(19) United States
(12) Patent Application Publication
(10) Pub. No.: US 2024/0296311 A1
(43) Pub. Date: Sep. 5, 2024

(54) NEURAL NETWORK PROCESSOR SYSTEM WITH RECONFIGURABLE NEURAL PROCESSING UNIT, AND METHOD OF OPERATING AND METHOD OF FORMING THEREOF

(71) Applicant: Agency for Science, Technology and Research, Singapore (SG)

(72) Inventors: Vishnu PARAMASIVAM, Singapore (SG); Wenyu JIANG, Singapore (SG); Anh Tuan DO, Singapore (SG); Ming Ming WONG, Singapore (SG); Aarthy MANI, Singapore (SG); Sumit Bam SHRESTHA, Singapore (SG)

(21) Appl. No.: 18/548,870

(22) PCT Filed: Mar. 3, 2023
(86) PCT No.: PCT/SG2021/050107

§ 371 Date: Sep. 1, 2023

(51) Int. Cl. G06N 3/045; G06N 3/091

(52) U.S. Cl. CPC G06N 3/045; G06N 3/091

(57) ABSTRACT

There is provided a neural network processor system including: a neural processing unit including a plurality of neural processing cores; a router network including a plurality of routers communicatively coupled to the plurality of neural processing cores, respectively; and a host processing unit communicatively coupled to the neural processing unit based on the router network and configured to coordinate the neural processing unit for performing neural network computations. Each neural processing core includes: a control register block configured to receive and store partial sum configuration information from the host processing unit; and a partial sum interface communicatively coupled to the control register block and configured to transmit a first partial sum neural packet generated by the neural processing core to a first another neural processing core of the plurality of neural processing cores and/or receive a second partial sum neural packet generated by a second another neural processing core of the plurality of neural processing cores, based on the partial sum configuration information stored in the neural processing core. Furthermore, a first set of neural processing cores of the plurality of neural processing cores are combinable based on the partial sum configuration information respectively stored therein to form a first neurosynaptic column chain. There is also provided a corresponding method of operating and a corresponding method of forming the neural network processor system.

### CROSS-REFERENCE TO RELATED APPLICATION

This application is a 371 National Stage of International Application No. PCT/SG2021/050107, filed on 3 Mar. 2021, the content of which being hereby incorporated by reference in its entirety for all purposes.

### TECHNICAL FIELD

The present invention generally relates to a neural network processor system with reconfigurable neural processing unit(s), a method of operating the neural network processor system and a method of forming the neural network processor system.

### BACKGROUND

Neurocores (which may interchangeably be referred to herein as neural processing cores) are hardware blocks (e.g., specialized hardware blocks) configured for neural network computations. For example, a cluster of these neurocores may be referred to as a neural processing unit (NPU). For illustration purpose and without limitation, FIG. 1 depicts a schematic drawing of an example NPU microarchitecture in hardware. In particular, FIG. 1 illustrates an example NPU 100 comprising a cluster of neurocores, along with an enlarged view of a synapse memory array 110 of one of the neurocores. Neurocores may be configured to realize flexible one-to-one mapping of neural networks, such as but not limited to, artificial neural networks (ANNs) and spiking neural networks (SNNs), with any network topology. The neurocores may maximize parallelism in network computations, and thus, may improve the overall system throughput. For example, each neurocore may be configured to run a neural network operation, and then send its computation results to another neurocore based on the mapping programmed into its respective routing lookup table (LUT).

While hardware-based solutions for neuromorphic applications may offer higher computational speed compared to software solutions, various embodiments of the present invention note the tradeoff relating to the maximum fan-in/fan-out of the neural network layers. This is limited by the maximum fan-in/fan-out supported by the individual neurocores within the NPU. Since the neurocores are implemented in hardware, conventionally, the fan-in/fan-out specifications are typically set in stone and cannot be changed. However, various embodiments of the present invention note that such conventional NPUs with hardware-based neurocores having fixed fan-in/fan-out specifications (e.g., with predetermined sizes) suffer from various inefficiencies and/or ineffectiveness in implementing neural networks (e.g., executing various neural network applications), and in particular, inefficient and/or ineffective neurocores utilization, resulting in suboptimal or inferior performances in a number of areas, such as but not limited to, power consumption, chip performance and area utilization.

A need therefore exists to provide a neural network processor system and related methods that seek to overcome, or at least ameliorate, one or more of deficiencies of conventional neural network processor systems, such as but not limited to, improving efficiency and/or effectiveness in implementing neural networks in NPU(s) with hardware-based neurocores, thereby, improving efficiency and/or effectiveness in performing neural network computations associated with one or more neural network applications. It is against this background that the present invention has been developed.

### SUMMARY

According to a first aspect of the present invention, there is provided a neural network processor system comprising:
a neural processing unit comprising a plurality of neural processing cores;
a router network comprising a plurality of routers communicatively coupled to the plurality of neural processing cores, respectively; and
a host processing unit communicatively coupled to the neural processing unit based on the router network and configured to coordinate the neural processing unit for performing neural network computations, wherein
each neural processing core of the plurality of neural processing cores comprises:
   a control register block configured to receive and store partial sum configuration information from the host processing unit; and
   a partial sum interface communicatively coupled to the control register block and configured to transmit a first partial sum neural packet generated by the neural processing core to a first another neural processing core of the plurality of neural processing cores and/or receive a second partial sum neural packet generated by a second another neural processing core of the plurality of neural processing cores, based on the partial sum configuration information stored in the neural processing core, and
a first set of neural processing cores of the plurality of neural processing cores are combinable based on the partial sum configuration information respectively stored therein to form a first neurosynaptic column chain.

According to a second aspect of the present invention, there is provided a method of operating a neural network processor system,
the neural network processor system comprising:
   a neural processing unit comprising a plurality of neural processing cores;
   a router network comprising a plurality of routers communicatively coupled to the plurality of neural processing cores, respectively; and
   a host processing unit communicatively coupled to the neural processing unit based on the router network and configured to coordinate the neural processing unit for performing neural network computations, wherein
   each neural processing core of the plurality of neural processing cores comprises:
      a control register block configured to receive and store partial sum configuration information from the host processing unit; and
      a partial sum interface communicatively coupled to the control register block and configured to transmit a first partial sum neural packet generated by the neural processing core to a first another neural processing core of the plurality of neural processing cores and/or receive a second partial sum neural packet generated by a second another neural processing core of the plurality of neural processing cores, based on the partial sum configuration information stored in the neural processing core, and
   a first set of neural processing cores of the plurality of neural processing cores are combinable based on the partial sum configuration information respectively stored therein to form a first neurosynaptic column chain, and
the method comprising:
   executing, by the host processing unit, one or more neural network applications;
   assigning, by the host processing unit, one or more neural network operations associated with the one or more neural network applications to the neural processing unit, comprising transmitting the respective partial sum configuration information to the control register block of each neural processing core of the first set of neural processing cores for combining the first set of neural processing cores to form the first neurosynaptic column chain; and
   performing, by the neural processing unit, neural network computations to obtain computation results in relation to the one or more neural network operations.

According to a third aspect of the present invention, there is provided a method of forming a neural network processor system, the method comprising:
providing a neural processing unit comprising a plurality of neural processing cores;
providing a router network comprising a plurality of routers communicatively coupled to the plurality of neural processing cores, respectively; and
providing a host processing unit communicatively coupled to the neural processing unit based on the router network and configured to coordinate the neural processing unit for performing neural network computations, wherein
each neural processing core of the plurality of neural processing cores comprises:
   a control register block configured to receive and store partial sum configuration information from the host processing unit; and
   a partial sum interface communicatively coupled to the control register block and configured to transmit a first partial sum neural packet generated by the neural processing core to a first another neural processing core of the plurality of neural processing cores and/or receive a second partial sum neural packet generated by a second another neural processing core of the plurality of neural processing cores, based on the partial sum configuration information stored in the neural processing core, and
a first set of neural processing cores of the plurality of neural processing cores are combinable based on the partial sum configuration information respectively stored therein to form a first neurosynaptic column chain.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 depicts a schematic drawing of an example neural processing unit (NPU) microarchitecture in hardware;

FIG. 2 depicts a schematic drawing of a neural network processor system according to various embodiments of the present invention;

FIG. 3 depicts a schematic flow diagram of a method of operating a neural network processor system according to various embodiments of the present invention;

FIG. 4A depicts a schematic flow diagram of a method of forming a neural network processor system according to various embodiments of the present invention;

FIG. 4B depicts a schematic flow diagram of an exemplary method of forming a neural network processor system according to various example embodiments of the present invention;

FIG. 5 depicts a schematic block diagram of an exemplary computer system in which a neural network processor system, according to various embodiments of the present invention, may be realized or implemented;

FIG. 6 depicts a schematic drawing illustrating a recombination example in relation to a NPU by clustering a number of individual neurocores into a single larger neurocore, for example, a 2×2 neurocore and a 3×3 neurocore;

FIG. 7 depicts a schematic drawing of an example microarchitecture of a neurocore that fully supports core recombination, according to various example embodiments of the present invention;

FIGS. 8A and 8B depict an example approach to partial sum configuration and multicasting configuration within neurocores, with at least four types of neighboring relationships, according to various example embodiments of the present invention;

FIGS. 9A and 9B illustrate exemplary data formats of supported router data packets, according to various example embodiments of the present invention;

FIG. 10 depicts a schematic drawing of an example neural network processor system, according to various example embodiments of the present invention;

FIGS. 11A and 11B show two example implementations of neurocore partial summation to form a larger neurosynaptic column (symmetrical and asymmetrical, respectively) for supporting a larger fan-in, according to various example embodiments of the present invention;

FIGS. 12A and 12B depict two example implementations of the neurocores performing multicasting via axon input neural packet duplication to form larger neurosynaptic rows (symmetrical and asymmetrical, respectively) for supporting a larger fan-out, according to various example embodiments of the present invention;

FIGS. 13A and 13B depict two other example implementations of multicasting to form larger neurosynaptic rows (symmetrical and asymmetrical, respectively) based on a neurocache block;

FIG. 14 depicts an example 9×9 scalable neurocore synapse array that allows for the truncation operation, according to various example embodiments of the present invention;

FIG. 15 depicts an example microarchitecture of the neuron computing unit, according to operation according to various example embodiments of the present invention;

FIG. 16 depicts an example SNN compiler flow that may be used to generate the configuration bitstream for the NPU, according to various example embodiments of the present invention;

FIG. 17 depicts an overview of an example host processor software control flow, according to various example embodiments of the present invention;

FIG. 18 depicts a table showing the neurocore usage for a particular spiking CNN architecture under various core configurations;

FIG. 19 depicts a table showing the classification accuracy for artificial neural networks (ANNs) trained for MNIST, according to various example embodiments of the present invention;

FIG. 20 depicts a table showing the benefit of core recombination for MNIST ANN when using smaller neurocores, according to various example embodiments of the present invention; and

FIG. 21 depicts a table showing the neurocore usage statistics for another example CNN-based image classification on an example dataset of 64×64×3 RGB input, according to various example embodiments of the present invention.

### DETAILED DESCRIPTION

Various embodiments of the present invention provide a neural network processor system with reconfigurable neural processing unit(s), a method of operating the neural network processor system and a method of forming the neural network processor system.

For example, as described in the background, conventional neural network processor systems comprising conventional neural processing units (NPUs) with hardware-based neurocores having fixed fan-in/fan-out specifications (e.g., with predetermined sizes) suffer from various inefficiencies and/or ineffectiveness in implementing neural networks (e.g., executing various neural network applications), and in particular, inefficient and/or ineffective neurocores utilization, resulting in suboptimal or inferior performances in a number of areas, such as but not limited to, power consumption, chip performance and area utilization. In this regard, various embodiments of the present invention provide a neural network processor system with reconfigurable (which may interchangeably be referred to herein as recombinable) neural processing unit(s) and related methods, such as a method of operating the neural network processor system and a method of forming the neural network processor system described herein, that seek to overcome, or at least ameliorate, one or more of deficiencies of conventional neural network processor systems, such as but not limited to, improving efficiency and/or effectiveness in implementing neural networks in NPU(s) with hardware-based neurocores, thereby, improving efficiency and/or effectiveness in performing neural network computations associated with one or more neural network applications.

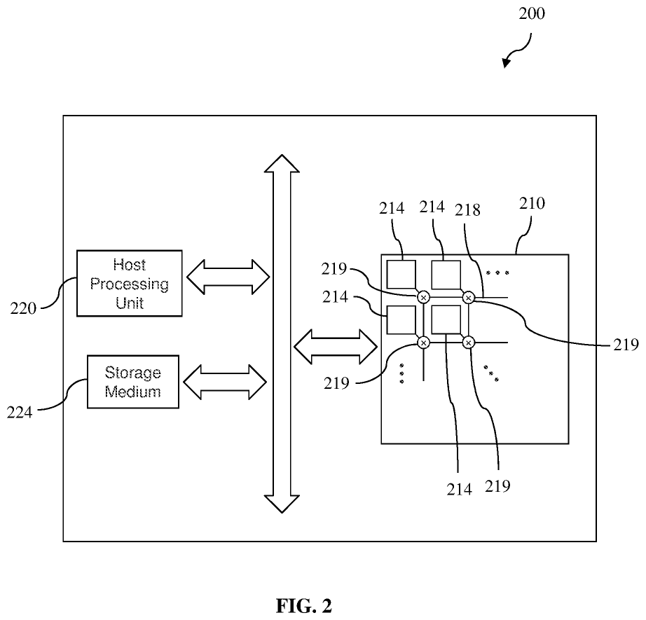

FIG. 2 depicts a schematic drawing of a neural network processor system 200 according to various embodiments of the present invention. The neural network processor system 200 comprises: a neural processing unit 210 comprising a plurality of neural processing cores 214; a router network 218 comprising a plurality of routers 219 communicatively coupled to the plurality of neural processing cores 214, respectively; and a host processing unit 220 communicatively coupled to the neural processing unit 210 based on the router network 218 and configured to coordinate the neural processing unit 210 for performing neural network computations. Each neural processing core of the plurality of neural processing cores 214 comprises: a control register block configured to receive and store partial sum configuration information from the host processing unit 220; and a partial sum interface communicatively coupled to the control register block and configured to transmit a first partial sum neural packet generated by the neural processing core to a first another neural processing core of the plurality of neural processing cores 214 and/or receive a second partial sum neural packet generated by a second another neural processing core of the plurality of neural processing cores 214, based on the partial sum configuration information stored in the neural processing core. In this regard, a first set of neural processing cores of the plurality of neural processing cores 214 are combinable based on the partial sum configuration information respectively stored therein to form a first neurosynaptic column chain.

For simplicity and clarity, the neural network processor system 200 is illustrated with only one NPU 210. However, it will be appreciated by a person skilled in the art that the neural network processor system 200 is not limited to only one NPU, and additional one or more NPUs (configured in the same, similar or corresponding manner as the NPU described herein according to various embodiments) may be included in the neural network processor system 200 as desired or as appropriate. In various embodiments, the above-mentioned plurality of neural processing cores 214 may be all of the neural processing cores in the NPU 210, or may be a subset thereof.

In various embodiments, in relation to the control register block of the neural processing core, by receiving and storing the partial sum configuration information, the control register block (and thus the neural processing core) may thus be programmed or configured with the partial sum configuration information for programming or configuring the neural processing core to perform a partial summation operation or function, including generating and transmitting the above-mentioned first partial sum neural packet and/or receiving the above-mentioned second partial sum neural packet. By way of example only and without limitations, based on the partial sum configuration information, the neural processing core may be configured to be a partial sum transmitter (or be in a partial sum transmitter mode, e.g., corresponding to the above-mentioned transmitting the first partial sum neural packet), a partial sum transceiver (or be in a partial sum transceiver mode, e.g., corresponding to the above-mentioned transmitting the first partial sum neural packet and the above-mentioned receiving the second partial sum neural packet) or a partial sum receiver (or be in a partial sum receiving mode, e.g., corresponding to the above-mentioned receiving the second partial sum neural packet). Accordingly, based on the partial sum configuration information respectively stored in each of the above-mentioned first set of neural processing cores, the above-mentioned first set of neural processing cores may be combined or configured (which may also be referred to herein as recombined or reconfigured) to form a first neurosynaptic column chain.

In various embodiments, the above-mentioned first another neural processing core of the plurality of neural processing cores 214 refers to an immediately succeeding neural processing core (with respect to the above-mentioned neural processing core) in the first neurosynaptic column chain, and the above-mentioned second another neural processing core of the plurality of neural processing cores 214 refers to an immediately preceding neural processing core (with respect to the above-mentioned neural processing core) in the first neurosynaptic column chain.

Accordingly, the neural network processor system 200 according to various embodiments advantageously comprises one or more NPUs, each NPU being reconfigurable (or recombinable) based on partial sum configuration information received by selected or assigned neural processing cores to form one or more neurosynaptic column chains therein. In this regard, the one or more neurosynaptic column chains formed are each able to effectively function, as a whole (i.e., with respect to the neurosynaptic column chain), with a larger neurosynaptic column (e.g., than an individual neural processing core), thereby, capable of supporting a larger fan-in as required or as desired. As a result, the neural processing cores within one or more NPUs can be better utilized (improve hardware utilization), thereby, improving performances in a number of areas, such as but not limited to, neural network computations, power consumption, chip performance and area utilization.

These advantages or technical effects, or other advantages or technical effects, will become more apparent to a person skilled in the art as the neural network processor system is described in more details according to various embodiments and example embodiments of the present invention.

In various embodiments, the partial sum configuration information respectively stored in the first set of neural processing cores are collectively configured to combine the first set of neural processing cores to form the first neurosynaptic column chain. For example, the plurality of partial sum configuration information received and stored by the first set of neural processing cores, respectively, are configured to set or program the first set of neural processing cores to collectively form the first neurosynaptic column chain.

In various embodiments, for each neural processing core of the first neurosynaptic column chain except a last neural processing core thereof, the partial sum interface of the neural processing core is configured to transmit the first partial sum neural packet generated to the first another neural processing core of the first neurosynaptic column chain based on relative core addressing information included in the partial sum configuration information stored in the neural processing core. For example, each of the neural processing core of the first neurosynaptic column chain, except the last neural processing core (which may also be referred to as the last remaining or final neural processing core) thereof, is configured, based on the respective partial sum configuration information, to be a partial sum transmitter or a partial sum transceiver. In this regard, the last neural processing core may be configured, based on the respective partial sum configuration information, to be a partial sum receiver, and thus, does not transmit any partial sum neural packet. Furthermore, each partial sum transmitter or transceiver is configured to transmit the first partial sum neural packet to the first another neural processing core based on the relative core addressing information stored in the respective partial sum configuration information.

In various embodiments, the relative core addressing information of the partial sum configuration information comprises directional data corresponding to or indicating a direction relative to the neural processing core at which the first another neural processing core of the first neurosynaptic column chain is located. In this regard, the first another neural processing core (with respect to the neural processing core) is immediately succeeding (i.e., immediately subsequent) the neural processing core in the first neurosynaptic column chain. By way of example only and without limitation, in the case of four possible directions, there may be four types of directional data, such as, a first directional data indicating a first direction (e.g., north) relative to the neural processing core, a second directional data indicating a second direction (e.g., cast) relative to the neural processing core, a third directional data indicating a third direction (e.g., south) relative to the neural processing core, and a fourth directional data indicating a fourth direction (e.g., west) relative to the neural processing core, at which the first another neural processing core of the first neurosynaptic column chain is located. It will be appreciated that the number of possible directions is not limited to four, and may be any number as appropriate or as desired, such as eight possible directions.

In various embodiments, the first partial sum neural packet generated by the neural processing core comprises an operation field comprising operation data indicating that the first partial sum neural packet is a partial sum neural packet (i.e., the neural packet is of a partial sum type), a payload field comprising partial sum data computed by the neural processing core and a destination field comprising destination data corresponding to the directional data stored in the neural processing core, and/or the second partial sum neural packet generated by the second another neural processing core comprises an operation field comprising operation data indicating that the second partial sum neural packet is a partial sum neural packet (i.e., the neural packet is of a partial sum type), a payload field comprising partial sum data computed by the second another neural processing core and a destination field comprising destination data corresponding to the directional data stored in the second another neural processing core.

In various embodiments, the first set of neural processing cores is configured to perform partial summations in parallel (e.g., at least substantially simultaneously). For example, each neural processing core of the first set of neural processing cores may perform its respective partial summation at least substantially simultaneously to generate partial sum data (e.g., partial sum value), and each intermediate neural processing core (i.e., between the first and last neural processing cores in the first neurosynaptic column chain) in the first set of neural processing cores may await to receive a partial sum neural packet (i.e., corresponding to the above-mentioned first partial sum neural packet) from an immediately preceding neural processing core. Upon receipt, the intermediate neural processing core may add its partial sum data generated to the partial sum data (which may be accumulated partial sum data) received in the partial sum neural packet received to produce a resultant partial sum data, and may then transmit the resultant partial sum data as accumulated partial sum data in a new partial sum neural packet to the immediately succeeding neural processing core. The last neural processing core in the first set of neural processing cores may add its partial sum data generated to the accumulated partial sum data received in the partial sum neural packet received to produce output neural data (of the first neurosynaptic column chain), and may then transmit the output neural data in an output neural data packet to another neural processing core or the host processing unit 220 as computation results in relation to one or more neural network operations assigned to the first neurosynaptic column chain.

In various embodiments, for the above-mentioned each neural processing core of the plurality of neural processing cores 214, the control register block of the neural processing core is further configured to receive and store axon input retransmission configuration information from the host processing unit 220. In this regard, the neural processing core further comprises an axon input retransmission interface communicatively coupled to the control register block and configured to transmit a duplicate axon input neural packet generated by the neural processing core to another neural processing core of the plurality of neural processing cores 214, based on the axon input retransmission configuration information stored in the neural processing core. The duplicate axon input neural packet may be generated by the axon input retransmission interface and comprises a duplicate of axon input row data (which may be referred to as duplicated axon input row data) of an axon input neural packet received by the neural processing core. Furthermore, a second set of neural processing cores of the plurality of neural processing cores 214 are combinable based on the axon input retransmission configuration information respectively stored therein to form a first neurosynaptic row chain.

In various embodiments, the second set of neural processing cores and the first set of neural processing cores may partially overlap. For example, they may share one common neural processing core.

In various embodiments, in relation to the control register block of the neural processing core, by receiving and storing the axon input retransmission configuration information, the control register block (and thus the neural processing core) may thus be programmed or configured with the axon input retransmission configuration information for programming or configuring the neural processing core to perform an axon input retransmission operation or function, including generating and transmitting the above-mentioned duplicate axon input neural packet. By way of example only and without limitations, based on the axon input retransmission configuration information, the neural processing core may be configured to be an axon input retransmission transmitter (or be in an axon input retransmission transmitter mode, e.g., corresponding to the above-mentioned transmitting the duplicate axon input neural packet), an axon input retransmission transceiver (or be in an axon input retransmission transceiver mode, e.g., receiving a duplicate axon input neural packet from a preceding neural processing core and transmitting a duplicate axon input neural packet (generated by the neural processing core) to a succeeding neural processing core) or an axon input retransmission receiver (or be in an axon input retransmission receiver mode, e.g., receiving a duplicate axon input neural packet from a preceding neural processing core). Accordingly, based on the axon input retransmission configuration information respectively stored in each of the above-mentioned second set of neural processing cores, the above-mentioned second set of neural processing cores may be combined or configured to form a first neurosynaptic row chain.

In various embodiments, the above-mentioned another neural processing core of the plurality of neural processing cores refers to an immediately succeeding neural processing core (with respect to the above-mentioned neural processing core) in the first neurosynaptic row chain.

Accordingly, the neural network processor system 200 according to various embodiments advantageously comprises one or more NPUs, each NPU being reconfigurable (or recombinable) further based on axon input retransmission configuration information received by selected or assigned neural processing cores to form one or more neurosynaptic row chains therein. In this regard, the one or more neurosynaptic row chains formed are each able to effectively function, as a whole (i.e., with respect to the neurosynaptic row chain), with a larger neurosynaptic row (e.g., than an individual neural processing core), thereby, capable of supporting a larger fan-out as required or as desired. As a result, with capability to support larger fan-in/fan-out requirements, the neural processing cores within one or more NPUs can be further better utilized (further improve hardware utilization), thereby, further improving performances in a number of areas, such as but not limited to, neural network computations, power consumption, chip performance and area utilization.

In various embodiments, the axon input retransmission configuration information respectively stored in the second set of neural processing cores are collectively configured to combine the second set of neural processing cores to form the first neurosynaptic row chain. For example, the plurality of axon input retransmission configuration information received and stored by the second set of neural processing cores, respectively, are configured to set or program the second set of neural processing cores to collectively form the first neurosynaptic row chain.

In various embodiments, for each neural processing core of the first neurosynaptic row chain except a last neural processing core thereof, the axon input retransmission interface of the neural processing core is configured to transmit the duplicate axon input neural packet generated to the above-mentioned another neural processing core of the first neurosynaptic row chain based on relative core addressing information included in the axon input retransmission configuration information stored in the neural processing core. For example, each of the neural processing core of the first neurosynaptic row chain, except the last neural processing core (which may also be referred to as the last remaining or final neural processing core) thereof, is configured, based on the respective axon input retransmission configuration information, to be an axon input transmitter or an axon input transceiver. In this regard, the last neural processing core may be configured, based on the respective axon input configuration information, to be an axon input receiver, and thus, does not retransmit any duplicate axon input neural packet received. Furthermore, each axon input transmitter or transceiver is configured to transmit the duplicate axon input neural packet to the above-mentioned another neural processing core based on the relative core addressing information in the respective axon input retransmission configuration information.

In various embodiments, the same as or similar to the relative core addressing information of the partial sum configuration information, the relative core addressing information of the axon input retransmission configuration information comprises directional data corresponding to or indicating a direction relative to the neural processing core at which the above-mentioned another neural processing core of the first neurosynaptic row chain is located. In this regard, the above-mentioned another neural processing core (with respect to the neural processing core) is immediately succeeding (i.e., immediately subsequent) the neural processing core in the first neurosynaptic row chain. By way of example only and without limitation, in the case of four possible directions, there may be four types of directional data, such as, a first directional data indicating a first direction (e.g., north) relative to the neural processing core, a second directional data indicating a second direction (e.g., cast) relative to the neural processing core, a third directional data indicating a third direction (e.g., south) relative to the neural processing core, and a fourth directional data indicating a fourth direction (e.g., west) relative to the neural processing core, at which the above-mentioned another neural processing core of the first neurosynaptic row chain is located. It will be appreciated that the number of possible directions is not limited to four, and may be any number as appropriate or as desired, such as eight possible directions.

In various embodiments, the duplicate axon input neural packet comprises an operation field comprising operation data indicating that the duplicate axon input neural packet is a duplicate axon input neural packet (i.e., the neural packet is of a duplicate axon input type, i.e., an axon input retransmission), a payload field comprising the duplicated axon input row data of an axon input neural packet received by the neural processing core and a destination field comprising destination data corresponding to the directional data stored in the neural processing core.

In various embodiments, the neural processing unit 210 further comprises a neural cache block, the router network 218 further comprises a router communicatively coupled to the neural cache block, and the host processing unit is further communicatively coupled to the neural cache block based on the router network 218. The neural cache block comprises: a control register block configured to receive and store axon input retransmission configuration information from the host processing unit 220; and an axon input retransmission configuration interface configured to duplicate axon input row data of an axon input neural packet received by the neural cache block to generate a duplicate axon input neural packet and transmit the duplicate axon input neural packet to another one or more neural processing cores of the plurality of neural processing cores 214 based on the axon input retransmission configuration information stored in the neural cache block. In this regard, a second set of neural processing cores of the plurality of neural processing cores 214 are combinable based on the axon input retransmission configuration information stored in the neural cache block to form a first neurosynaptic row chain. In various embodiments associated with the neural cache block, the axon input retransmission configuration information comprises core addressing information for the above-mentioned another one or more neural processing cores. In various embodiments, the core addressing information may include address data corresponding to or indicating one or more addresses at which the above-mentioned another one or more neural processing cores, respectively, are located.

In various embodiments, the neural cache block may comprise a memory buffer configured to buffer neural data.

In various embodiments, for the above-mentioned each neural processing core of the plurality of neural processing cores 214, the control register block of the neural processing core is further configured to receive and store core truncation configuration information from the host processing unit 220. In this regard, the neural processing core further comprises a core truncator communicatively coupled to the control register block and configured to modify a neurosynaptic row count and/or a neurosynaptic column count of the neural processing core based on the core truncation configuration information stored in the neural processing core. By way of examples only and without limitation, column truncation may be achieved based on analog neurosynaptic circuits, such as switchable transistors provided at an end of each neurosynaptic column, and row truncation may be achieved based on an axon input masking logic for disabling selected rows. Accordingly, bases on these examples, the core truncator may include analog neurosynaptic circuits for modifying the neurosynaptic column count of the neural processing core and axon input masking logic for modifying the neurosynaptic row count of the neural processing core.

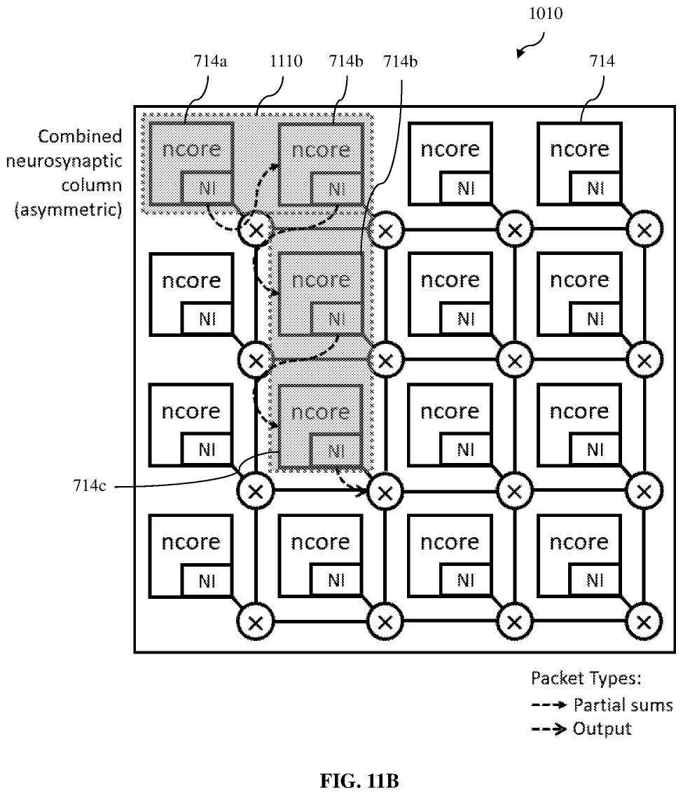

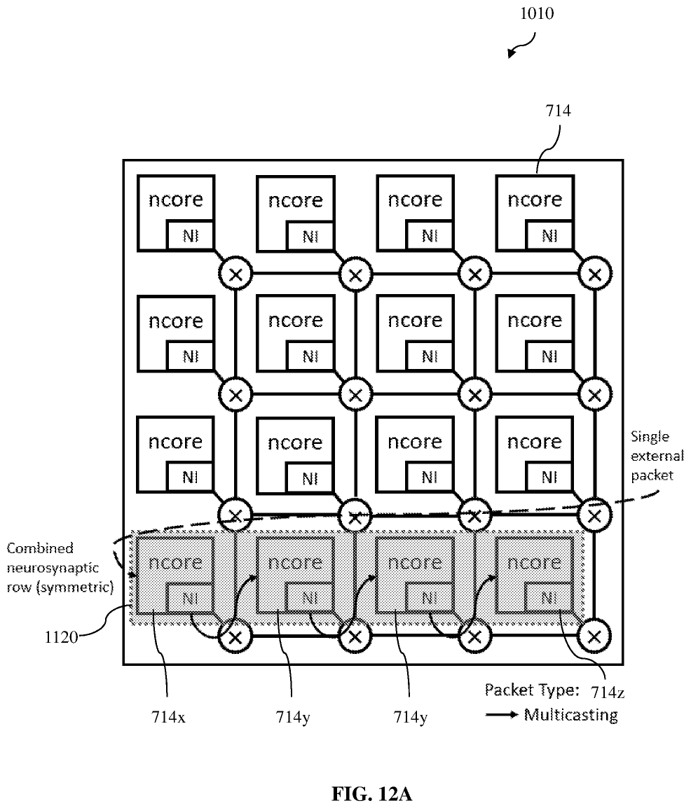

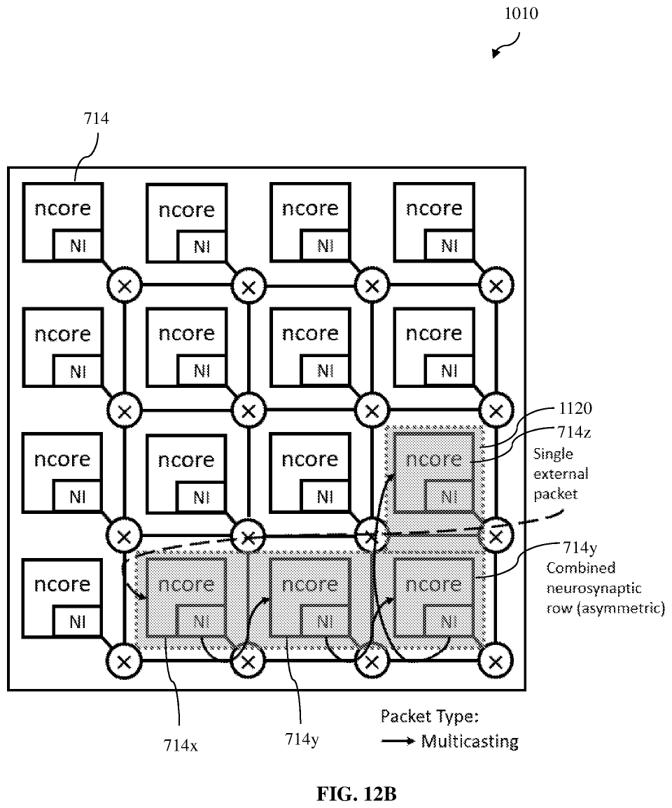

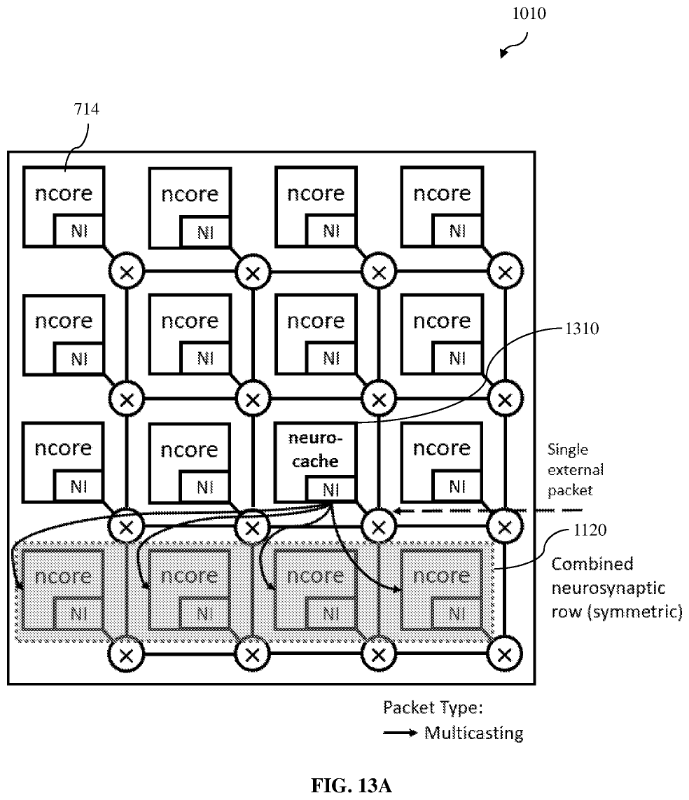

In various embodiments, the first neurosynaptic column chain is symmetrical or asymmetrical, and the first neurosynaptic row chain is symmetrical or asymmetrical. That is, the first neurosynaptic column chain (or any additional neurosynaptic column chain) is not limited to being symmetrical, i.e., not limited a straight column, but may also be asymmetrical, such as illustrated in FIG. 11B as an example. Similarly, the first neurosynaptic row chain (or any additional neurosynaptic row chain) is not limited to being symmetrical, i.e., not limited to a straight row, but may also be asymmetrical, such as illustrated in FIG. 12B as an example.

In various embodiments, a third set of neural processing cores of the plurality of neural processing cores 214 are combinable based on the partial sum configuration information respectively stored in the first set of neural processing cores and the axon input retransmission configuration information respectively stored in the second set of neural processing cores to form a first combined neural processing core comprising the first set of neural processing cores forming the first neurosynaptic column chain and the second set of neural processing cores forming the first neurosynaptic row chain. In other words, a first combined neural processing core may be formed including the first neurosynaptic column chain and the first neurosynaptic row chain.

In various embodiments, the first combined neural processing core further comprises one or more first additional sets of neural processing cores forming one or more additional neurosynaptic column chains and one or more second additional sets of neural processing cores forming one or more additional neurosynaptic row chains. In other words, the first combined neural processing core may be formed including the first neurosynaptic column chain and the one or more additional neurosynaptic column chains, and the first neurosynaptic row chain and the one or more additional neurosynaptic row chains.

In various embodiments, the neural network processor system 200 further comprises a fabric bridge. In this regard, the host processing unit 220 is communicatively coupled to the neural processing unit 210 (or to each neural processing unit) via the fabric bridge and the router network 218. In particular, the host processing unit 220 may be communicatively coupled to the router network 218 via the fabric bridge.

In various embodiments, the router network 218 may comprise a respective router subnetwork for each neural processing unit. In this regard, a router subnetwork for a neural processing unit may comprise a plurality of routers communicatively coupled to the plurality of neural processing cores, respectively, in the neural processing unit. In other words, each neural processing unit has a router subnetwork associated therewith, the router subnetwork comprises a plurality of routers communicatively coupled to the plurality of neural processing cores, respectively, of the neural processing unit. Accordingly, each of the plurality of neural processing cores in the neural processing unit is configured to communicate with another one or more neural processing cores via the router coupled to (and associated with) the neural processing core.

In various embodiments, the router network 218 may further comprise a respective global router for each neural processing unit. In this regard, a global router for a neural processing unit is communicatively coupled to the router subnetwork for the neural processing unit. For example, the router network 218 may be configured to route neural packets to and/or from a neural processing unit via the respective global router associated with the neural processing unit.

In various embodiments, each of the plurality of neural processing cores 214 comprises a memory synapse array configured to perform in-memory neural network computations.

In various embodiments, in each neural processing unit, the plurality of neural processing core blocks is arranged in a two-dimensional (2D) array (comprising rows and columns) and each neural processing core has an associated unique address based on its position in the 2D array and the neural processing unit it belongs to. For example, each neural processing core may have an address based on the row and column at which it is located in the 2D array.

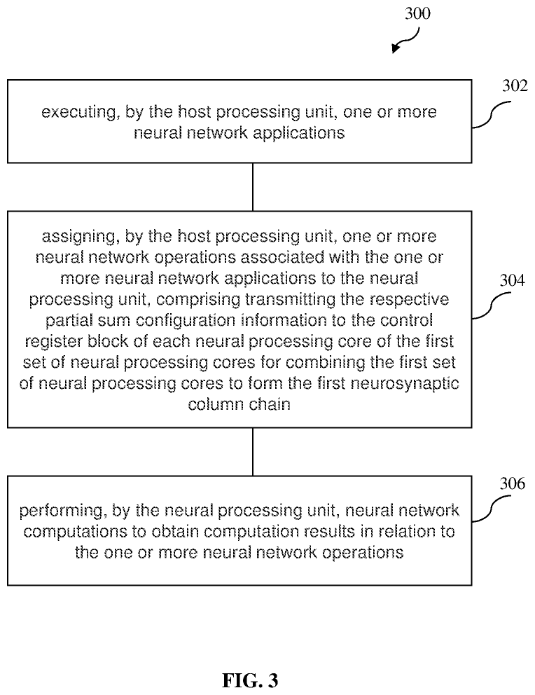

FIG. 3 depicts a schematic flow diagram of a method 300 of operating a neural network processor system according to various embodiments of the present invention, such as the neural network processor system 200 as described hereinbefore with reference to FIG. 2 according to various embodiments. The method 300 comprising: executing (at 302), by the host processing unit 220, one or more neural network applications; assigning (at 304), by the host processing unit 220, one or more neural network operations associated with the one or more neural network applications to the neural processing unit 210, comprising transmitting the respective partial sum configuration information to the control register block of each neural processing core 214 of the above-mentioned first set of neural processing cores for combining the first set of neural processing cores to form the first neurosynaptic column chain; and performing (at 306), by the neural processing unit 210, neural network computations to obtain computation results in relation to the one or more neural network operations. For example, the computation results may then be transmitted back to the host processing unit 220 for further processing based on the one or more neural network applications.

In various embodiments, the above-mentioned assigning, by the host processing unit 210, the one or more neural network operations associated with the one or more neural network applications to the neural processing unit 210, further comprises transmitting axon input retransmission configuration information to the neural processing unit 210 for combining a second set of neural processing cores to form a first neurosynaptic row chain, such as described hereinbefore according to various embodiments.

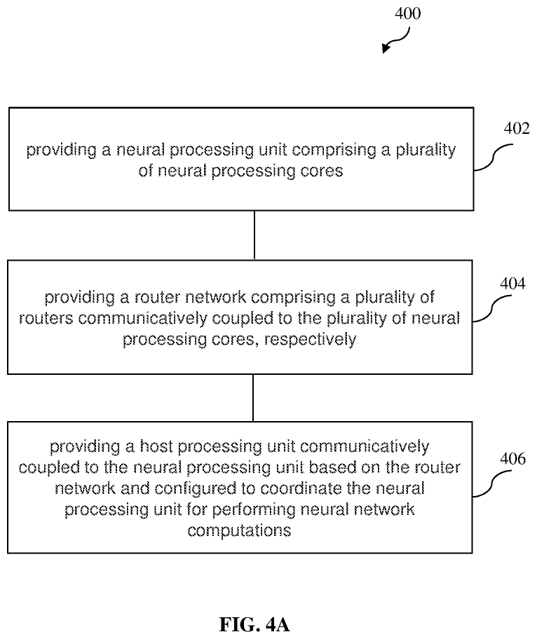

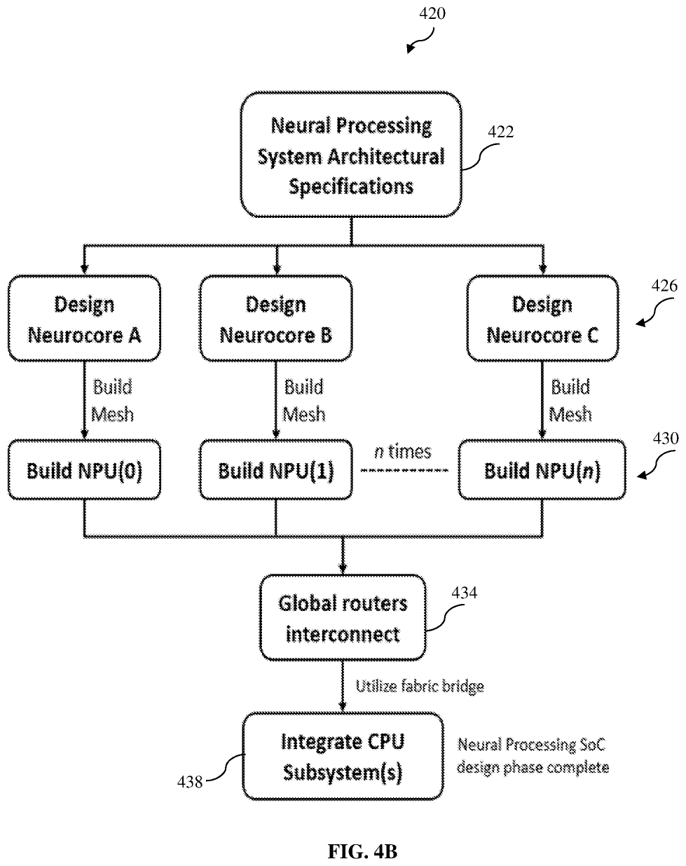

FIG. 4A depicts a schematic flow diagram of a method 400 of forming a neural network processor system according to various embodiments of the present invention, such as the neural network processor system 200 as described hereinbefore with reference to FIG. 2 according to various embodiments. The method 400 comprises: providing (at 302, e.g., forming) a neural processing unit 210 comprising a plurality of neural processing cores 214; providing (at 304, e.g., forming) a router network 218 comprising a plurality of routers 219 communicatively coupled to the plurality of neural processing cores 214, respectively; and providing (at 306, e.g., forming) a host processing unit 220 communicatively coupled to the neural processing unit 210 based on the router network 218 and configured to coordinate the neural processing unit 210 for performing neural network computations. Each neural processing core of the plurality of neural processing cores 214 comprises: a control register block configured to receive and store partial sum configuration information from the host processing unit 210; and a partial sum interface communicatively coupled to the control register block and configured to transmit a first partial sum neural packet generated by the neural processing core to a first another neural processing core of the plurality of neural processing cores 214 and/or receive a second partial sum neural packet generated by a second another neural processing core of the plurality of neural processing cores 214, based on the partial sum configuration information stored in the neural processing core. In this regard, a first set of neural processing cores of the plurality of neural processing cores 214 are combinable based on the partial sum configuration information respectively stored therein to form a first neurosynaptic column chain.

In various embodiments, for the above-mentioned each neural processing core of the plurality of neural processing cores 214, the control register block of the neural processing core is further configured to receive and store axon input retransmission configuration information from the host processing unit. In this regard, the neural processing core further comprises an axon input retransmission interface communicatively coupled to the control register block and configured to duplicate axon input row data of an axon input neural packet received by the neural processing core to generate a duplicate axon input neural packet and to transmit the duplicate axon input neural packet to another neural processing core of the plurality of neural processing cores 214, based on the axon input retransmission configuration information stored in the neural processing core. In this regard, a second set of neural processing cores of the plurality of neural processing cores 214 are combinable based on the axon input retransmission configuration information respectively stored therein to form a first neurosynaptic row chain.

In various embodiments, the method 400 is for forming the neural network processor system 200 as described hereinbefore with reference to FIG. 2, therefore, various steps or operations of the method 400 may correspond to forming, providing or configuring various components or elements of the neural network processor system 200 as described hereinbefore according to various embodiments, and thus such corresponding steps or operations need not be repeated with respect to the method 400 for clarity and conciseness. In other words, various embodiments described herein in context of the neural network processor system 200 are analogously valid for the method 400 (e.g., for forming the neural network processor system 200 having various components and configurations as described hereinbefore according to various embodiments), and vice versa.

By way of an example only and without limitation, FIG. 4B depicts a schematic flow diagram of an exemplary method 420 of forming a neural network processor system according to various example embodiments of the present invention, such as the neural network processor system 200 as described hereinbefore with reference to FIG. 2. The method 420 comprises obtaining (at 422) architectural specifications for the neural network processor system desired to be configured/formed according to various example embodiments of the present invention. For example, requirements associated with the architectural specifications may be obtained from an application developer, and the requirements may then be translated (or transformed) into NPU specifications. With these NPU specifications, the individual neural processing core blocks for each NPU may then be formed or designed (at 426). As described hereinbefore, the NPU may comprise a plurality of neural processing cores (e.g., repeating units of neural processing cores in an array, such as a two-dimensional (2D) array). At the circuit level, neural processing cores associated with each NPU may be algorithmically stitched together as a mesh (or array) to form the respective NPU (i.e., design automation) (at 430), which can significantly simplify engineering effort. Subsequently, the NPUs may be connected to each other (e.g., via global routers) (at 434), and may then be connected to a CPU subsystem (at 438).

In various embodiments, the neural network processor system 200 may be formed as an integrated neural processing circuit. The neural network processor system 200 may also be embodied as a device or an apparatus.

A computing system, a controller, a microcontroller or any other system providing a processing capability may be presented according to various embodiments in the present disclosure. Such a system may be taken to include one or more processors and one or more computer-readable storage mediums. For example, the neural network processor system 200 described hereinbefore may include a number of processing units (e.g., a host processing unit (e.g., one or more CPUs) 220 and one or more NPUs 210) and one or more computer-readable storage medium (or memory) 224 which are for example used in various processing carried out therein as described herein. A memory or computer-readable storage medium used in various embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof. Thus, in various embodiments, a “circuit” may be a hard-wired logic circuit or a programmable logic circuit such as a programmable processor, e.g., a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with various alternative embodiments. Similarly, a “module” may be a portion of a system according to various embodiments in the present invention and may encompass a “circuit” as above, or may be understood to be any kind of a logic-implementing entity therefrom.

Some portions of the present disclosure are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “coordinating”, “performing”, “receiving”, “storing”, “transmitting”, “generating”, “executing”. “assigning”, or the like, refer to the actions and processes of a computer system, or similar electronic device, that manipulates and transforms data represented as physical quantities within the computer system into other data similarly represented as physical quantities within the computer system or other information storage, transmission or display devices.

The present specification also discloses a system (e.g., which may also be embodied as a device or an apparatus) for performing the operations/functions of the method(s) described herein. Such a system or apparatus may be specially constructed for the required purposes, or may comprise a general purpose computer or other device selectively activated or reconfigured by a computer program stored in the computer. The algorithms presented herein are not inherently related to any particular computer or other apparatus. Various general purpose machines may be used with computer programs in accordance with the teachings herein. Alternatively, the construction of more specialized apparatus to perform the required method steps may be appropriate.

In addition, the present specification also at least implicitly discloses a computer program or software/functional module, in that it would be apparent to the person skilled in the art that various individual steps of the methods described herein may be put into effect by computer code. The computer program is not intended to be limited to any particular programming language and implementation thereof. It will be appreciated that a variety of programming languages and coding thereof may be used to implement the methods/techniques of the disclosure contained herein. Moreover, the computer program is not intended to be limited to any particular control flow. There are many other variants of the computer program, which can use different control flows without departing from the spirit or scope of the present invention. It will be appreciated to a person skilled in the art that various modules may be software module(s) realized by computer program(s) or set(s) of instructions executable by a computer processor to perform the required functions, or may be hardware module(s) being functional hardware unit(s) designed to perform the required functions. It will also be appreciated that a combination of hardware and software modules may be implemented.

Furthermore, one or more of the steps of the computer program/module or method may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer program when loaded and executed on such a general-purpose computer effectively results in an apparatus that implements the steps of the methods described herein.

In various embodiments, there is provided a computer program product, embodied in one or more computer-readable storage mediums (non-transitory computer-readable storage medium), comprising instructions executable by one or more computer processors (e.g., the host processing unit 220) to perform a method 300 of operating a neural network processor system as described hereinbefore with reference to FIG. 3. Accordingly, various computer programs or modules described herein may be stored in a computer program product receivable by a system therein for execution by at least one processor of the system to perform the respective functions.

Various software or functional modules described herein may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the software or functional module(s) described herein can also be implemented as a combination of hardware and software modules.

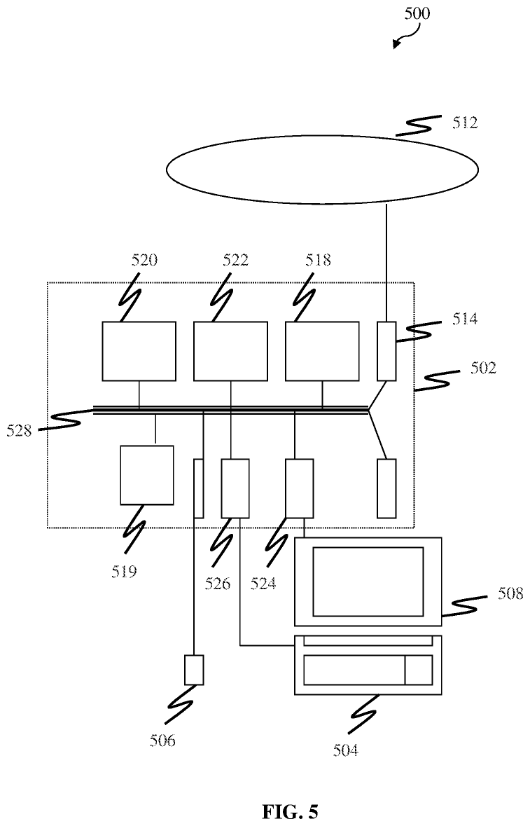

In various embodiments, the neural network processor system 200 may be realized by or embodied as any computer system (e.g., portable or desktop computer system, such as tablet computers, laptop computers, mobile communications devices (e.g., smart phones), and so on) including the host processing unit 220 and the NPU 210 configured as described hereinbefore according to various embodiments, such as a computer system 500 as schematically shown in FIG. 5 as an example only and without limitation. Various methods/steps or functional modules may be implemented as software, such as a computer program (e.g., one or more neural network applications) being executed within the computer system 500, and instructing the computer system 500 (in particular, one or more processors therein) to conduct the methods/functions of various embodiments described herein. The computer system 500 may comprise a computer module 502, input modules, such as a keyboard 504 and a mouse 506, and a plurality of output devices such as a display 508. The computer module 502 may be connected to a computer network 512 via a suitable transceiver device 514, to enable access to, e.g., the Internet or other network systems such as Local Area Network (LAN) or Wide Area Network (WAN). The computer module 502 in the example may include a processor 518 (e.g., corresponding to the host processing unit 220 of the neural network processor system 200 as described herein according to various embodiments) for executing various instructions (e.g., neural network application(s)), a neural network processor 519 (e.g., corresponding to the neural processing unit 210 of the neural network processor system 200 as described herein according to various embodiments), a Random Access Memory (RAM) 520 and a Read Only Memory (ROM) 522. The neural network processor 519 may be coupled to the interconnected bus (system bus) 528 via one or more fabric bridges. The computer module 502 may also include a number of Input/Output (I/O) interfaces, for example I/O interface 524 to the display 508, and I/O interface 526 to the keyboard 504. The components of the computer module 502 typically communicate via an interconnected bus 528 and in a manner known to the person skilled in the relevant art.

It will be appreciated to a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

Any reference to an element or a feature herein using a designation such as “first”. “second” and so forth does not limit the quantity or order of such elements or features, unless stated or the context requires otherwise. For example, such designations are used herein as a convenient way of distinguishing between two or more elements or instances of an element. Thus, a reference to first and second elements does not necessarily mean that only two elements can be employed, or that the first element must precede the second element. In addition, a phrase referring to “at least one of” a list of items refers to any single item therein or any combination of two or more items therein.

In order that the present invention may be readily understood and put into practical effect, various example embodiments of the present invention will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art.

Various example embodiments, in general, relate to the field of hardware implementation of neural networks, such as artificial neural networks (ANNs) and spiking neural networks (SNNs). In particular, various example embodiments disclose a method in which low power block-based neural processing units (NPUs) can internally scale and reconfigure itself to support different fan-in/fan-out requirements. This is independent of the maximum fan-in/fan-out configuration of each of the NPU's internal hardware cores (which may interchangeably be referred to herein as neural computing units, neural processing cores or simply as neurocores). These neurocores are responsible for implementing the individual layers of a neural network. Accordingly, the method according to various example embodiments advantageously overcomes the fan-in/fan-out limitations of neural network layers implemented using these hardware-based neurocores with predetermined sizes. A scalable neural packet encoding format with parameterizable bitwidths for its fields is disclosed for inter-neurocore communications according to various example embodiments of the present invention, in order to support core recombination. According to various example embodiments, the scalable neural packet encoding format includes support for special packets, such as partial summation, multicasting, and debug packets. This allows for an optimal NPU hardware implementation, for example, in regards to power consumption, chip performance and area utilization. Accordingly, various example embodiments provide a method for recombination of neurosynaptic cores to form heterogeneous neural networks (which may herein be referred to as the recombination method) and a method to operate the same.

As described in the background, neurocores are hardware blocks configured for neural network computations. Neurocores may be configured to realize flexible one-to-one mapping of neural networks, such as but not limited to ANNs and SNNs, with any network topology. The neurocores may maximize parallelism in network computations, and thus, improve the overall system throughput. For example, each neurocore may be configured to run a neural network operation, and then send its computation results to another neurocore based on the mapping programmed into its respective routing lookup table (LUT).

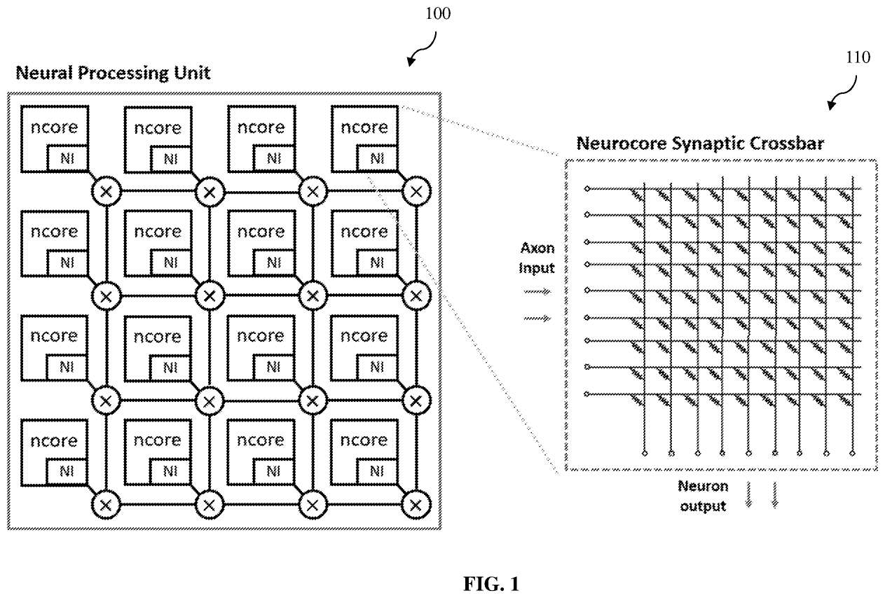

Communications between neurocores may be performed via a fabric of interconnecting routers, interconnected as a network-on-chip (NoC) mesh, such as shown in FIG. 1 (e.g., denoted by “x”). These routers may be specifically designed to handle outputs from a neural network layer (e.g., spikes in case of SNN) and route them along XYZ coordinates. Typically, an asynchronous interface protocol is employed, making circuit placement on hardware very flexible. The NoC topology is not limited to only this configuration however, as other NoC topologies may also be applied for the recombination method according to various example embodiments of the present invention. Hence, it will be appreciated by a person skilled in the art that the present invention is not limited to any particular configuration of the router network, such as the configuration as shown in FIG. 1.

While hardware-based solutions for neuromorphic applications may offer higher computational speed compared to software solutions, various example embodiments of the present invention note the tradeoff relating to the maximum fan-in/fan-out of the neural network layers. This is limited by the maximum fan-in/fan-out supported by the individual neurocores within the NPU. Since the neurocores are implemented in hardware, conventionally, the fan-in/fan-out specifications are typically set in stone and cannot be changed. However, various example embodiments of the present invention note that such conventional NPUs with hardware-based neurocores having fixed fan-in/fan-out specifications (e.g., with predetermined sizes) suffer from various inefficiencies and/or ineffectiveness in implementing neural networks (e.g., executing various neural network applications), and in particular, inefficient and/or ineffective neurocores utilization, resulting in suboptimal or inferior performances in various areas, such as but not limited to, power consumption, chip performance and area utilization.

Accordingly, various example embodiments of the present invention provide a neural network processor system with reconfigurable neural processing unit(s) and related methods, such as a method of operating the neural network processor system and a method of forming the neural network processor system described herein, that seek to overcome, or at least ameliorate, one or more of deficiencies of conventional neural network processor systems, such as but not limited to, improving efficiency and/or effectiveness in implementing neural networks in NPU(s) with hardware-based neurocores, thereby improving efficiency and/or effectiveness in performing neural network computations. For example, according to various example embodiments, the recombination method is provided for clustering (or combining) hardware-based neurocores, allowing it to form larger and/or fine grain sized virtual cores and hence capable of supporting larger heterogeneous neural networks, and may be implemented using large scale integrated processing circuits.

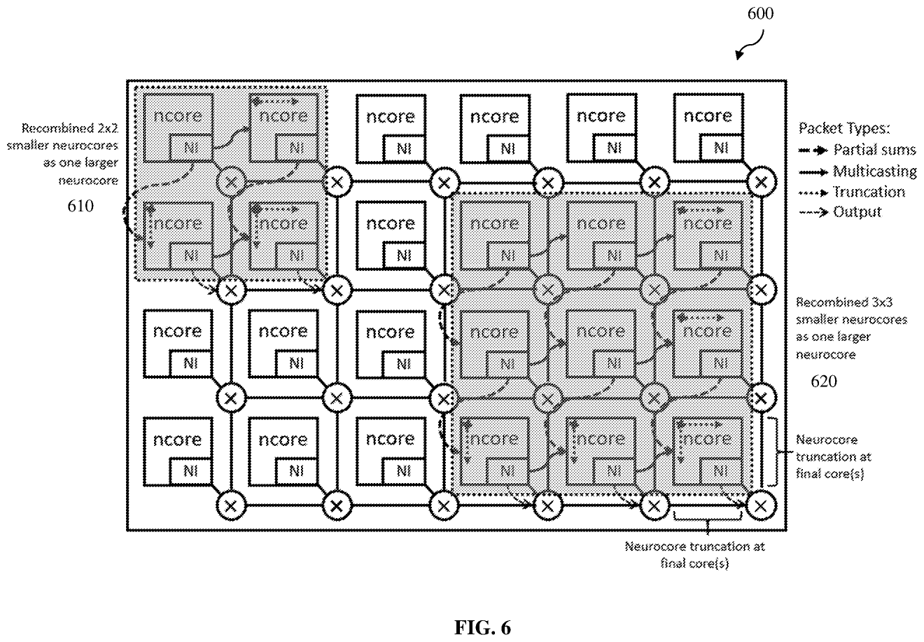

For illustration purpose and without limitation, FIG. 6 depicts a schematic drawing illustrating a recombination example in relation to a neural processing unit 600 by clustering (or combining) a number of individual neurocores into a single larger neurocore, such as a 2×2 neurocore 610 and/or a 3×3 neurocore 620, using partial summation operations, multicasting operations and truncation operations, according to various example embodiments of the present invention.

### Hardware Design/Architecture

### Neurocore Microarchitecture

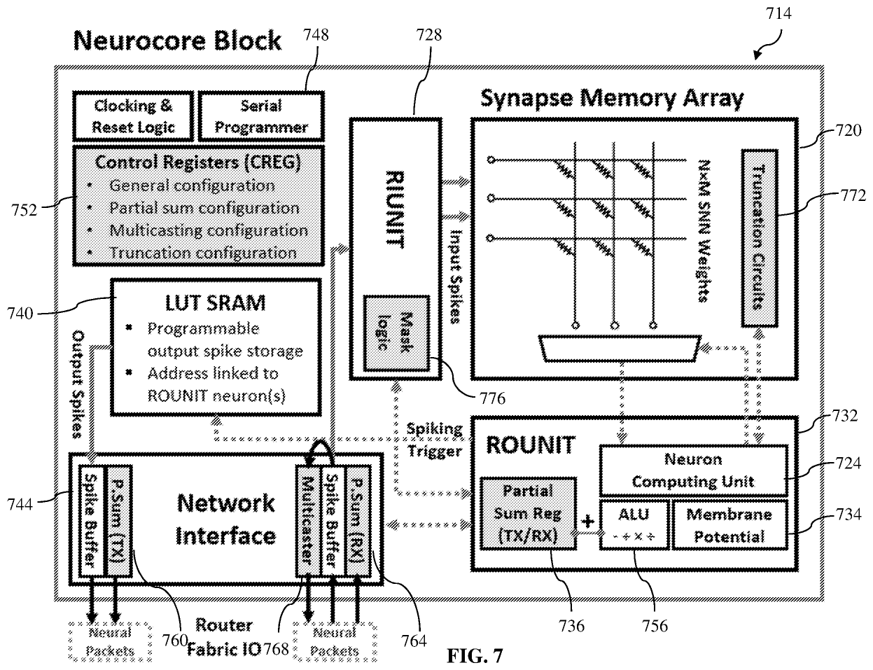

For illustration purpose and without limitation, FIG. 7 depicts a schematic drawing of an example microarchitecture of a neurocore 714 (hardware-based neurocore) (e.g., corresponding to each neural processing core of the plurality of neural processing cores 214 as described hereinbefore according to various embodiments of the present invention) that fully supports core recombination, according to various example embodiments of the present invention. The neurocore 714 comprises at least one memory array 720 capable of in-memory matrix computations, a neuron computing unit 724, an input scheduling unit (RIUNIT) 728, an output scheduling unit (ROUNIT) 732, a memory array (e.g., membrane potential block) 734 for storing intermediate matrix computation outputs 736, at least one look-up table 740 for storing the destination of the forwarded packets, a network interface 744, a programming unit 748, and a control register (CREG) module or block 752. This facilitates the neurocore 714 in handling neural packet transmission, reception and processing as part of the neuromorphic architecture. The neuron computing unit 724 is implemented within the ROUNIT module 732, and is capable of handling various different neuron computing model options via its arithmetic logic unit (ALU) 756. The neuron computing unit 732 may be configured to handle the synapse array output and compute the resulting neuron output packets, which may then be forwarded to the routing fabric via the network interface (NI) 744.

In terms of neurosynaptic operation, the neurocore may compute the incoming axon input packets and send neuron output packets accordingly. For example, in the case of SNN, when the membrane potential of a neuron exceeds a pre-defined threshold, an output neural packet may be generated and sent to its corresponding destination. The destination may either be the same or a different neurocore. The address of the destination neurocore and axon row may be stored in a lookup table (LUT). For example, if the kin neuron fires, contents of the LUT's km row may be read out and sent to the output buffer inside the network interface. Once a packet is placed in the output buffer, the neuron's membrane potential is reset. Subsequently, the network interface may push the packet to the corresponding router so that it can be forwarded to its intended destination.

According to various example embodiments, to support core recombination, the neurocore 714 may be configured with the following hardware modules embedded therein (depicted as shaded blocks in FIG. 7), by way of an example only and without limitation.

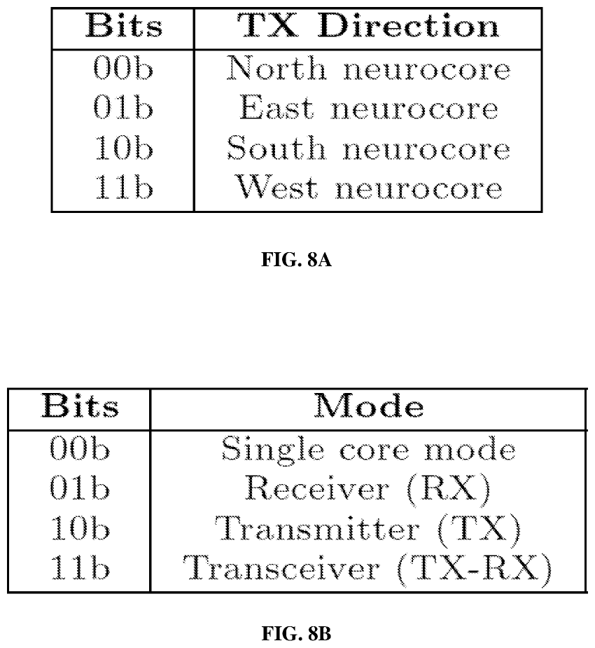

Each neurocore 714 may have a control register (CREG) module 752 with externally programmable entries for general configuration, multicasting configuration (e.g., corresponding to the axon input retransmission configuration information as described hereinbefore according to various embodiments), partial summation configuration (e.g., corresponding to the partial sum configuration information as described hereinbefore according to various embodiments), and truncation configuration (e.g., corresponding to the core truncation configuration information as described hereinbefore according to various embodiments). By way of examples only and without limitations, the values programmed in the CREG module 752 may be based on the information encoding format or style as shown in FIGS. 8A and 8B. In particular, FIGS. 8A and 8B illustrates example minimalistic approach to partial sum configuration and multicasting configuration within neurocores, with at least four types of neighboring relationships, according to various example embodiments of the present invention. As an example, a neurocore may be configured to be a partial sum receiver and a multicast transceiver (receiver-transmitter) that duplicates packets northwards, and only use 96 out of 128 available synapses to save power consumption.

The NI 744 comprises an embedded partial sum module or interface (e.g., a partial sum transmitter interface 760 and/or a partial sum receiver interface 764, such as corresponding to the partial sum interface as described hereinbefore according to various embodiments) that is coupled (e.g., directly coupled) with the partial sum register 736 with the neuron computing unit 724. The partial sum interface is configured to operate based on the partial sum configuration information (which may also be referred to herein as partial sum configuration entry or partial sum mode entry) stored or programmed into the CREG 752. For example, based on the Tables shown in FIGS. 8A and 8B, if the partial sum mode entry at the CREG 752 of the neurocore 714 is set to parameter value of 10b, and its corresponding transfer direction entry is set to a parameter value of 10b, then the neurocore 714 is in the partial sum transmitter mode and is configured to forward its partial sum packets to the neurocore that is southwards relative thereto. As another example, if the partial sum mode entry is set to a parameter value of 00b, then the neurocore 714 is in the single core mode and the transfer direction entry has no effect.

The NI 744 is configured to be able to transmit, receive and decode relative packets (e.g., multicast and partial sum types) based on the above-mentioned CREG configurations, in addition to regular absolute packets.

The NI 744 comprises an embedded multicast module or interface 768 (e.g., corresponding to the axon input retransmission interface as described hereinbefore according to various embodiments) configured to retransmit an axon input neural packet (i.e., the payload of the axon input neural packet) to a neighboring core, based on the multicasting configuration information (which may also be referred to herein as multicasting configuration entry or multicasting mode entry) stored or programmed in the CREG 752. For example, if the multicasting mode entry at the CREG 752 of the neurocore 714 is set to a parameter value of 01b, then the neurocore is in the multicast packet receiver mode and the transfer direction entry no effect. As another example, if the multicasting mode entry is set to a parameter value of 11b, and its corresponding transfer direction entry is set to a parameter value of 01b, then the neurocore 714 is in the multicasting transceiver (transmitter-receiver) mode, and will duplicate any received multicast packet (i.e., the payload of the received multicast packet) to the neurocore that is castwards relative to the neurocore 714.

The synaptic memory array 720 is configured to support synaptic column truncation, which allows unused neurosynaptic columns to be disabled. The synaptic column truncation may be controlled according to the truncation configuration information (e.g., including column truncation configuration information or entry) stored in the CREG 752 of the neurocore 714, which may be decoded accordingly by a neurosynaptic circuitry (e.g., truncation circuits 772). In various example embodiments, analog neurosynaptic circuits may achieve column truncation by using switchable transistors at the end of each synaptic column, or column truncation may also be implemented digitally within the neuron computational unit 724 logic. For example, if a neurocore 714 with 256 synaptic columns has its column truncation configuration entry set to 56, then only the first 56 neurosynaptic columns may function, and the remaining 200 neurosynaptic columns may not function.

The synaptic memory array 720 is further configured to support synaptic row truncation, which allows unused neurosynaptic rows to be disabled. The synaptic row truncation may be controlled according to the truncation configuration information (e.g., further including row truncation configuration information or entry) stored in the CREG 752 of the neurocore 714, which may be decoded accordingly by a neurosynaptic circuitry. In various example embodiments, row truncation may be achieved via axon input masking logic 776 for disabling selected synaptic rows, such that neurosynaptic packets that go into selected disabled synaptic rows are forced to be always zero. For example, if a neurocore with 256 synaptic rows has its row truncation configuration entry set to 26, then only the first 26 neurosynaptic rows may function, and the remaining 230 neurosynaptic rows may not function.

The NPU routers (e.g., corresponding to the plurality of routers 219 of the router network 218 as described hereinbefore according to various embodiments) are configured to be able to transmit, receive and decode all the four different types of neural packets accordingly, namely, normal, debug, partial sum, and multicast types. For example, the router arbitration circuits are able to recognize partial sum and multicast packets as relative packets, which may then be routed to the targeted neighbouring core. For example, debug packets may be routed out of the NPU and into the CPU (e.g., corresponding to the host processing unit 220 as described hereinbefore according to various embodiments) for diagnostic purposes. For example, normal packets may be routed to its destination neurocore accordingly.

### Scalable Hardware Neural Packet Format

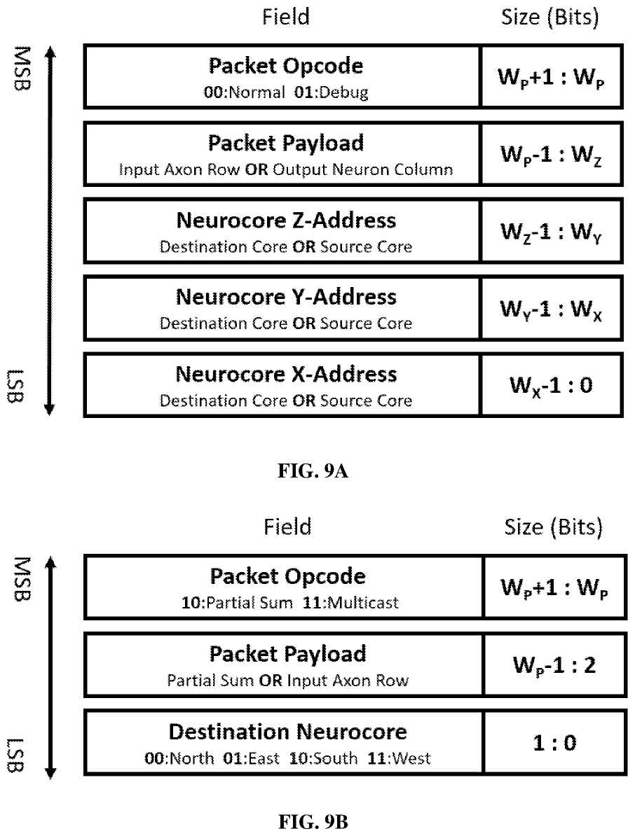

FIGS. 9A and 9B illustrate exemplary data formats of supported router data packets, according to various example embodiments of the present invention. In particular, FIG. 9A depicts a neural packet encoding diagram for absolute packets, and FIG. 9B depicts a neural packet encoding diagram for relative packets. There may be two different supported neural packet formats, namely, absolute packets (e.g., normal or debug type) and relative packets (e.g., partial sum or multicast type). In various example embodiments, each router and neurocore 714 has its own (X, Y, Z) location address, and packets may encode this information within itself to indicate the destination/source for routing. For example, the X and Y coordinates may denote a two-dimensional localized address (or position) of the neurocore 714 within the corresponding NPU, and the Z coordinate may denote the address (or position) of the NPU itself. This facilitates a seamless mechanism in which data packets can be routed internally or across NPUs in a neural network processor system.

In various example embodiments, each field within the neural packet (e.g., as shown in FIGS. 9A and 9B) has a parameterizable bitwidth, and may be optimized to fit the finalized size of the hardware NPU at tapeout. The cumulative bitwidths for X, Y, Z, payload and opcode are denoted as W_{X}, W_{Y}, W_{Z}, W_{P} (payload bitwidth), and W_{O} (opcode bitwidth) (with W_{O}=W_{P+2} in this example), respectively. Accordingly, the whole packet size may be the sum of these fields. This leads to a scalable packet format that optimizes the hardware area to only what is necessary, depending on the neurocore array size and configuration within the finalized NPU chip.

For example, there may be two types of absolute neural packets as shown in FIG. 9A, namely, normal packets (opcode 0 (binary number 00)) and debug packets (opcode 1 (binary number 01)). Normal packets are standard packets, including the input axon row that is to be triggered at its destination neurocore based on the coordinate stored in the XYZ fields. Debug packets are essentially the opposite of normal packets, including the output neuron column ID that fired within the source neurocore, and the coordinate is stored in the XYZ fields. For example, debug packets may be automatically routed to the CPU, and may be only generated by neurocores when debug mode is enabled. During this mode, for every normal packet generated, a complementing debug packet may follow.

In various example embodiments, there are two types of relative neural packets as shown in FIG. 9B, namely, partial sum packets (opcode 2 (binary number 10)) (e.g., corresponding to the first or second partial sum neural packet as described hereinbefore according to various embodiments), and multicast packets (opcode 3 (binary number 11)) (e.g., corresponding to the duplicate axon input neural packet as described hereinbefore according to various embodiments). For example, partial sum packets convey the membrane potential update of neurocores from one point to another within the recombined column chain, and multicast packets re-transmit the input axon row that is to be triggered to a neighboring core within the recombined row chain. According to various example embodiments, when the partial summation and multicasting operations are combined together, core recombination and clustering can be achieved as shown in FIG. 6. In various example embodiments, both packet types utilize a relative core addressing scheme instead of the full XYZ addressing scheme to simplify design, integration, and end-user software deployment. In various example embodiments, at minimum, the relative addressing scheme supports packets to be sent northward, eastward, southward, and westward with respect to the neurocore 714.

### System-Level Integration

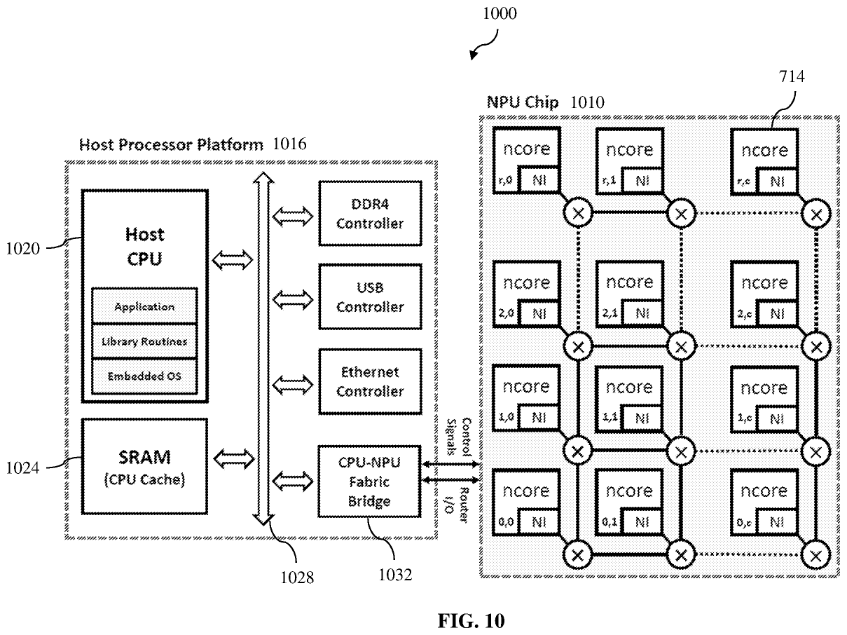

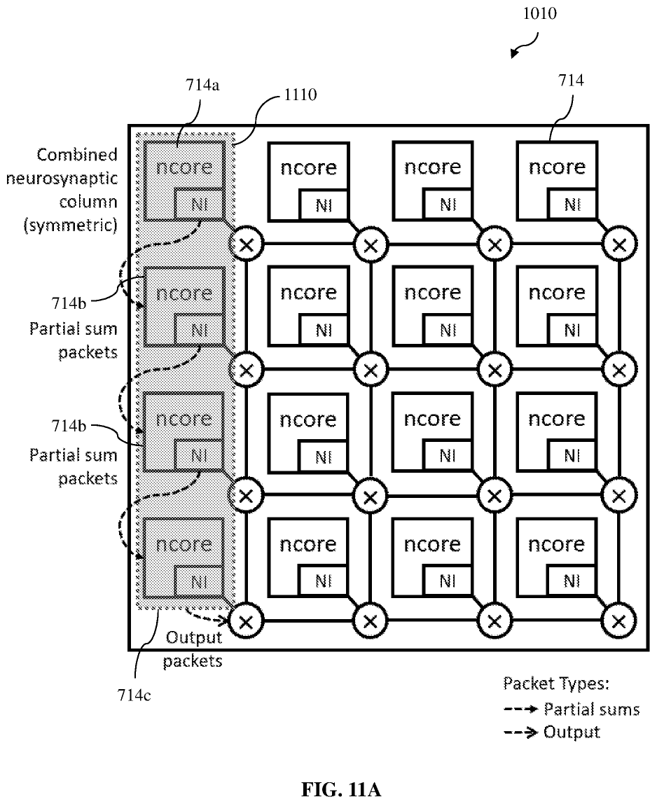

FIG. 10 depicts a schematic drawing of an example neural network processor system 1000 (e.g., corresponding to the neural network processor system 200 as described hereinbefore according to various embodiments) according to various example embodiments of the present invention. an example implementation of system-level NPU hardware 1010 (e.g., corresponding to the neural processing unit 210 as described hereinbefore according to various embodiments) coupled with a host processor 1016, including a host CPU 1020 (e.g., corresponding to the host processing unit 220 as described hereinbefore according to various embodiments), as a primary controller, according to various example embodiments of the present invention. In particular, FIG. 10 depicts an example implementation of an NPU 1010 coupled with a CPU master controller 1020. As shown in FIG. 10, the host processor platform 1016 may comprise at least one general purpose processor 1020, a CPU cache 1024 (e.g., corresponding to the storage medium 224 as described hereinbefore according to various embodiments), at least one system bus 1028, and a CPU-NPU fabric bridge 1032. The host processor platform 1016 may further comprise various I/O communication blocks (e.g., DDR4 controller, USB controller, Ethernet controller) and various memory blocks. For example, running an embedded operating system onchip would allow the target application to make full use of various software stacks, such as the filesystem, networking stacks, as well as various processing libraries.

The CPU 1020 may be the primary master of the neural network processor system 1000, and it enables the application developer the freedom to allocate the available hardware resources to target multiple neurocomputing applications, all running concurrently. The CPU 1020 may be tasked to synchronize and coordinate a plurality of the neurocores for the target application to ensure smooth operation. The CPU 1020 may also be responsible for communicating with other miscellaneous I/O peripherals.

In various example embodiments, for the CPU 1020 to send data and obtain calculation results from the NPU 1010, a dedicated CPU-NPU fabric bridge 1032 may be utilized. This is due to CPU system bus utilizing a different communication protocol when compared to the NPU's routers. The fabric bridge 1032 includes submodules that are configured to correctly handle the respective communication protocols. Furthermore, the fabric bridge 1032 may comprise a bridge status register for allowing the application developer to constantly monitor the status of the bridge transactions, and is able to ascertain the busy or idle states of all the communication interfaces.

### Neurocore Recombination Methodology

A method for recombining neurocores to configure the NPU 1010 to support larger fan-in/fan-out requirements will now be described in further details according to various example embodiments. In various example embodiments, three different operational modes are supported by the NPU hardware, namely, (1) neurocore partial summations; (2) neurocore multicasting; and (3) neurocore truncation. All of these neurocore operations are graphically illustrated in FIG. 6.

In various example embodiments, when implementing partial summations and core recombination/concatenation, there are three kinds of relevant synaptic operations, namely, (1) axon input neural packets (e.g. input spike packets for SNN); (2) partial sums, as intermediate outputs between neurocores, and is always multi-bit; (3) neuron output neural packets (e.g., output spike packets for SNN). The implemented mechanism for recombining neurocores and axon inputs is configured to lead to the desired behavior for the resulting neuron outputs. Furthermore, in various example embodiments, traffic going into the NPU hardware 1010 is controlled by the external host processor 1020, but internal NPU neural packet traffic is handled by the internal neurocores 714 and routing hardware.

### Neurocore Partial Summation

FIGS. 11A and 11B show example implementations of a neurocore partial summation operation or method according to various example embodiments of the present invention. In particular, FIGS. 11A and 11B show two example implementations of neurocore partial summation to form a larger neurosynaptic column (symmetrical and asymmetrical, respectively) for supporting a larger fan-in. In general, there are no limitations in terms of which neurocore 714 can be used for building this larger neurosynaptic column, and the neurocores 714 may be chained either symmetrically or asymmetrically, as illustrated in FIGS. 11A and 11B, respectively.

In FIGS. 11A and 11B, each neurocore 714 in a neurosynaptic column chain 1110 may be set or configured in one of three modes for neurocore partial sum configurations, namely. (1) partial sum transmitter; (2) partial sum transceiver; and (3) partial sum receiver. In various example embodiments, the very first neurocore 714a in the neurosynaptic column chain 1110 is a partial sum transmitter (TX), the neurocores 714b in between (which may be referred to as intermediate neurocores) are partial sum transceivers (TX-RX), and the very last neurocore 714c in the neurosynaptic column chain 1110 is a partial sum receiver (RX). In various example embodiments, the relationship between these chained neurocores 714a, 714b, 714c may be encoded in terms of neighbouring relationship (e.g., corresponding to the relative core addressing information as described hereinbefore according to various embodiments, such as north, cast, south, or west with respect to the originating neurocore). The neighboring relationship and these three different behavioral configurations may be encoded in a number of bits. By way of an example only and without limitation, a minimalistic form of implementing the above-mentioned neighbouring relationship encoding is shown in FIGS. 8A and 8B.

A partial summation flow based on neurocore recombination will now be described according to various example embodiments of the present invention. The first neurocore 714a in the neurosynaptic column chain 1110 computes its neurosynaptic partial sum, after which, it sends the computed partial sum value in a relative packet (or more specifically, a partial sum packet) to the next (immediately succeeding) neurocore 714b in the neurosynaptic column chain 1110 through the corresponding router. In various example embodiments, the partial sum configuration entries of all transmitter/transceiver neurocores 714a, 714b (i.e., except the last neurocore 714c) in the neurosynaptic column chain 1110 comprise relative location information (e.g., north/east/south/west) of the next neurocore in the neurosynaptic column chain 1110, such that the partial sum packet generated by the neurocore may be transmitted to the next neurocore based on the relative location information. For example, it is not necessary for any one of the transceiver/receiver neurocores to be aware of which neurocore is the predecessor in the neurosynaptic column chain 1110. Each transceiver/receiver neurocore 714b in the neurosynaptic column chain 1110, upon receiving a partial sum packet from a predecessor neurocore, may add its partial sum computed to the partial sum received in the partial sum packet to produce an accumulated partial sum, and generate a new partial sum packet comprising the accumulated partial sum to the next neurocore in the neurosynaptic column chain 1110. The final neurocore 714c in the neurosynaptic chain 1110 may also have its partial sum configuration entry configured in the CREG 752, and is configured based on its partial sum configuration entry to be in the receiver mode only. For example, the final neurocore 714c may send the resulting final sum generated (e.g., by adding its partial sum computed and the accumulated partial sum received) out in a regular neurosynaptic output packet, either to the next neural network layer or directly back to the host processor platform 1016.

With this method, the neurocore columns can be artificially recombined in a seamless manner to extend the fan-in requirements for any given target application. Accordingly, the neurocore recombination methodology described according to various example embodiments of the present invention allows for a simple and minimalistic implementation, avoiding cumbersome and convoluted solutions to core recombination, as well as simplifying both the neurocore and router in terms of hardware design complexity.

In various example embodiments, as another advantage associated with the partial summation operation, all the neurocores 714a, 714b, 714c in the neurosynaptic column chain 1110 may be configured to run (i.e., compute partial sum) in parallel, thereby improving performance significantly when compared to an equivalent larger sized neurocore. For example, a technique to efficiently enable such parallelism while maintaining low-power may be based on synchronized time multiplexing. In neurocores with a crossbar architecture, it may be preferred to enumerate through each column/neuron for computation sequentially, instead of computing all of it simultaneously. When implementing the partial summation operation, all individual neurocores 714a, 714b, 714c in the neurosynaptic column chain 1110 may simultaneously (or substantially simultaneously) perform its synaptic column computation (relatively large latency in time taken). Furthermore, each partial sum transceiver/receiver neurocore 714b, 714c thereof may wait for the predecessor neurocore to transmit its partial sum value (relatively very small latency in time taken) thereto. After receiving the partial sum value, the transceiver/receiver neurocore 714b, 714c may then add its partial sum value computed to the partial sum value received to obtain a resultant partial sum value (which may be referred to herein as the accumulated partial sum value). In the case of a transceiver neurocore 714b, the transceiver neurocore 714b may transmit the accumulated partial sum value in a partial sum packet to the successor neurocore in the neurosynaptic column chain 1110. In the case of a receiver neurocore 714c, the receiver neurocore 714c may transmit the accumulated partial sum value in an output packet to another neurocore or the host processing unit 1020 as computation results in relation to one or more neural network operations assigned to the neurosynaptic column chain 1110. This allows for simultaneous computing of the synaptic columns for all neurocores in the neurosynaptic column chain 1110, and the same applies for even very large combined neurocore columns. For example, if there are N neurocores in the neurosynaptic column chain 1110, then the receiver neurocore 714c may experience only a latency of N×t_{fwd} on getting the final weighted partial sum, where t_{fwd} is the forwarding and processing delay of a partial sum packet. With various implementations, the latency N×t_{fwd} obtained may be very small compared to the duration of the synaptic column computation. Therefore, simultaneous or parallel computing may be applied using this methodology, which is an added advantage.

### Neurocore Multicasting

To support a combined fan-out for axon inputs, a neurocore multicasting (or retransmission) operation method is provided according to various example embodiments of the present invention. Axon input neural packets (e.g., spikes for SNN) from the host controller only targets a single neurocore in the NPU, which is a problem as the same axon input neural packet is also needed by the other neurocores in a neurosynaptic row chain along the synaptic row direction (as opposed to along the synaptic column direction for the partial summation operation). In this regard, a method to multicast (or retransmit) axon input neural packets is implemented according to various example embodiments of the present invention. According to various example embodiments, several different methods are provided, such as, via neurocore neural packet duplication at the network interface, specialized hardware structures (e.g., neurocache), and using the host processor to send multiple axon input neural packets.

FIGS. 12A and 12B show neurocore multicasting examples using the axon input neural packet duplication technique according to various example embodiments of the present invention. In particular, FIGS. 12A and 12B depict two example implementations of the neurocores 714 performing multicasting via axon input neural packet (spikes for SNN) duplication to form larger neurosynaptic rows (symmetrical and asymmetrical, respectively) for supporting a larger fan-out. In general, there are no limitations in terms of which neurocore 714 can be used for building this larger neurosynaptic row, and the neurocores 714 may be chained either symmetrically or asymmetrically, as illustrated in FIGS. 12A and 12B, respectively. The axon input neural packet duplication is preferred according to various example embodiments as it was found to be the most efficient form of multicasting (or retransmission) for neurocore recombination due to its minimalistic design approach, as well as minimizing the amount of NoC traffic.

In the axon input neural packet duplication mode, an original input packet, comprising an axon input row data, may be received or consumed by the first neurocore 714x in the neurosynaptic row chain 1120. Upon receiving the original input packet, the first neurocore 714x may then immediately generate a duplicate of this axon input row data and sends it in a relative packet (or more specifically, a duplicate axon input neural packet) to the successor (i.e., subsequent) neurocore. In this regard, the axon input row data is the payload of the input packet or the relative packet that is duplicated and included in the relative packet. Each multicast transceiver neurocore 714y in the neurosynaptic row chain 1120, upon receiving a duplicate axon input neural packet from a predecessor neurocore, may also generate a duplicate of the axon input row data included in the duplicate axon input neural packet received and then transmits a new duplicate axon input neural packet including the duplicated axon input row data to the successor neurocore. In various example embodiments, the duplicate axon input neural packet is constructed or generated accordingly by the neurocore's network interface 744. In particular, the network interface 744 of the neurocore 714 may be configured to support the axon input neural packet duplication function, and may be provided with the core addressing information of the immediately succeeding neurocore in the neurosynaptic row chain 1120 from the CREG 752. In various example embodiments, in the same or similar manner as described hereinbefore with respect to the partial sum operation, this core addressing information may be expressed in terms of the relative direction of the next neighboring neurocore in the neurosynaptic row chain 1120 (e.g., north, cast, south or west), whereby only minimal configuration may be utilized for the neurocores 714 by a simple encoding format for neighboring/successor neurocore information and the role of the current neurocore in the neurosynaptic row chain 1120, such as the parameter values and the corresponding relative directions shown in FIG. 8A. The final neurocore 714z in the neurosynaptic row chain 1120 may also have its multicast configuration entry configured in the CREG 752, and is configured based on the multicast configuration entry to be in the multicast receiver mode. In other words, the final neurocore 714z does not retransmit the duplicate axon input neural packet received to another neurocore.

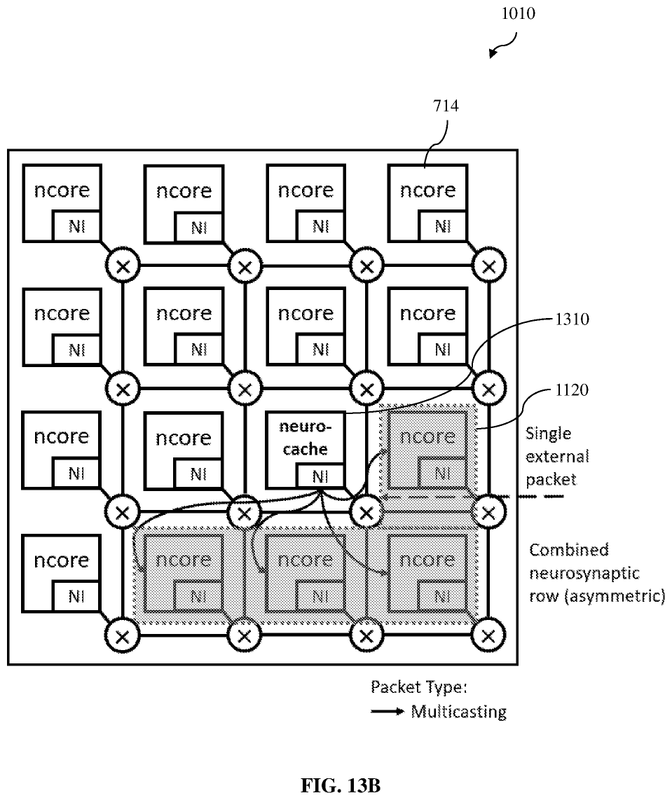

In various other embodiments, the host processor 1020 may be configured to store or imprint scheduled tasks/neural events within a neurocache subsystem 1310 to improve the system efficiency during operation. The neurocache 1310 may be analogous to the biological brain stem, and be able to perform neural packet splitting for multicasting, delaying, and buffering. FIGS. 13A and 13B show a neurocore multicasting example using a neurocache hardware block 1310. In particular, FIGS. 13A and 13B show additional example implementations of multicasting to form larger neurosynaptic rows (symmetrical and asymmetrical, respectively), but using neurocache structures. An advantage of using the neurocache unit 1310 is that the neurocores in the same recombined neurosynaptic row 1120 do not necessarily have to be next to each other (neighboring or immediately adjacent neurocores). This may be useful for recombining rows that are comprised of neurocores that are not immediately neighboring each other.

Accordingly, with the neurocore multicasting method, a neurocore row can be artificially combined in a seamless manner to meet the fan-out requirements of the target application, while also resulting in improved performance due to parallelism. The performance improvement is similar to the parallelism described hereinbefore with respect to the partial summation method or operation. Multicasting can be efficiently achieved with the methods described with reference to FIGS. 12A and 12B and FIGS. 13A and 13B, but is not limited as such. For example, in various example embodiments, a host processor 1020 may be employed to emulate neural packet multicasting in the form of multiple unicasting, and send them to selected neurocores 714 in the NPU 1010 to form a neurosynaptic row chain 1120.

### Neurocore Truncation

The neurocore truncation operation will now be described according to various example embodiments of the present invention. This neurocore truncation operation may be applied to fine-tune the specific or exact fan-in/fan-out requirements. Otherwise, the recombined neurocore may be limited to values that are multiples of the hardwired neurocore synaptic rows/columns. For example, if a particular neural network requires a 204×239 neurosynapse configuration on a 256×256 hardware neurocore due to smaller input image size, the neurocore truncation operation may be applied to achieve this seamlessly and enjoy the benefits that using a smaller neurocore would entail. Neurocore truncation can work seamlessly with synchronized time multiplexing described hereinbefore with respect to the partial summation method or operation. In various example embodiments, analog neurosynaptic circuits may achieve column truncation by using switchable transistors at an end of each neurosynaptic column, or the column truncation may also be implemented digitally within the neuron computational unit 724 logic. In various example embodiments, row truncation may be achieved via axon input masking logic 776 for disabling selected synaptic rows, such that neurosynaptic packets that go into selected disabled synaptic rows are forced to be always zero.

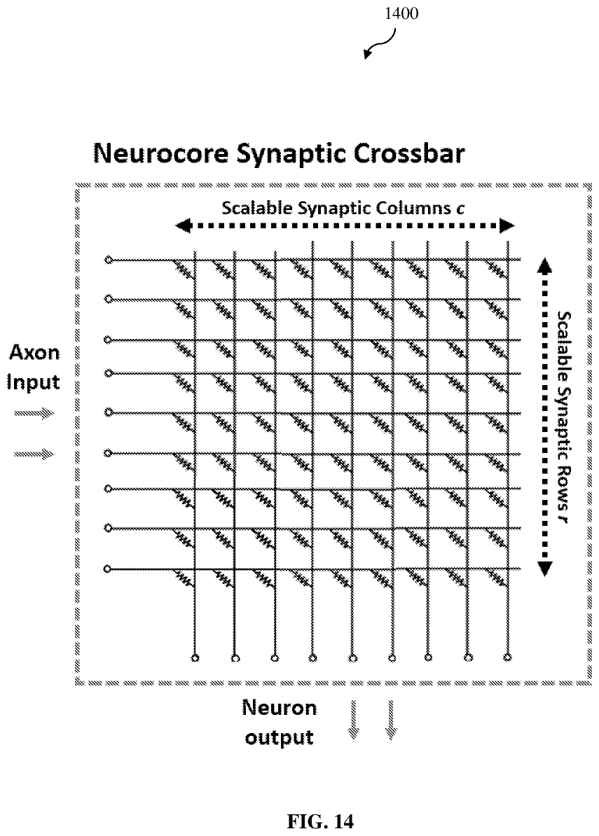

FIG. 14 shows an example 9×9 scalable neurocore synapse array 1400 that allows for the truncation operation according to various example embodiments of the present invention, with configurable synaptic row count r and synaptic column count c. In particular, FIG. 14 shows an example 9×9 neurocore synapse array 1400 that supports synaptic truncation to support scalable fan-in/fan-out requirements. The scalable neurocore synapse array 1400 may not be programmed with values that exceed the physical dimensions of the hardware neurocore synapse array. Accordingly, the truncation operation may be handled internally within the individual neurocore in the combined row or column, and may be configured based on the corresponding r and c values.

Accordingly, with the neurocore truncation operation, a synaptic row and column can advantageously be configured (internally) to fine-tune the fan-in/fan-out size of any individual neurocore 714. This can be designed in various different ways within the microarchitecture of the neurocore itself, and it typically does not require much hardware resources to achieve high efficiency within the logic domain. Accordingly, when implemented, the neurocore truncation operation according to various example embodiments of the present invention can result in better overall power consumption and may complete the computations faster, which are significantly advantageous in neuromorphic hardware.

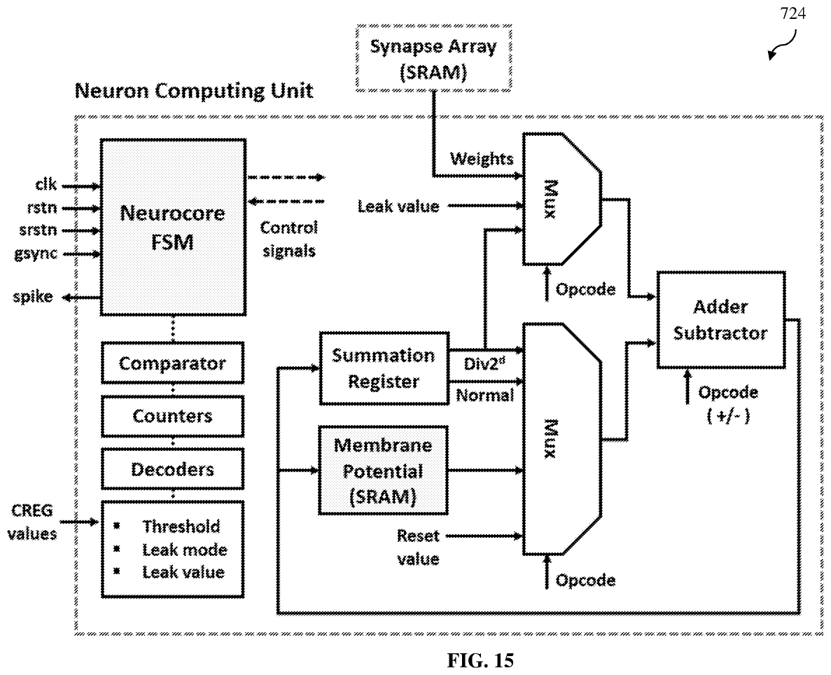

FIG. 15 shows an example microarchitecture of the neuron computing unit 724 located within the ROUNIT 732, according to operation according to various example embodiments of the present invention. The neuron computing unit 724 is capable of handling various different neuron computing model types, and is operable to process the synapse array output and compute the resulting spikes, which may then be forwarded to the routing fabric via the network interface (NI) 744. The operations of various different neuron computing model types are known to a person skilled in the art and thus need not be described in detail herein. For example, the synapse array output may be processed by accumulating synaptic weight values against a membrane potential with the help of an accumulator register (or summation register). All of which may be switched accordingly by a number of multiplexors in a timely manner by the neurocore FSM.

### Prototype System Setup and Evaluation

Host Processor Control Flow with SNN Compiler

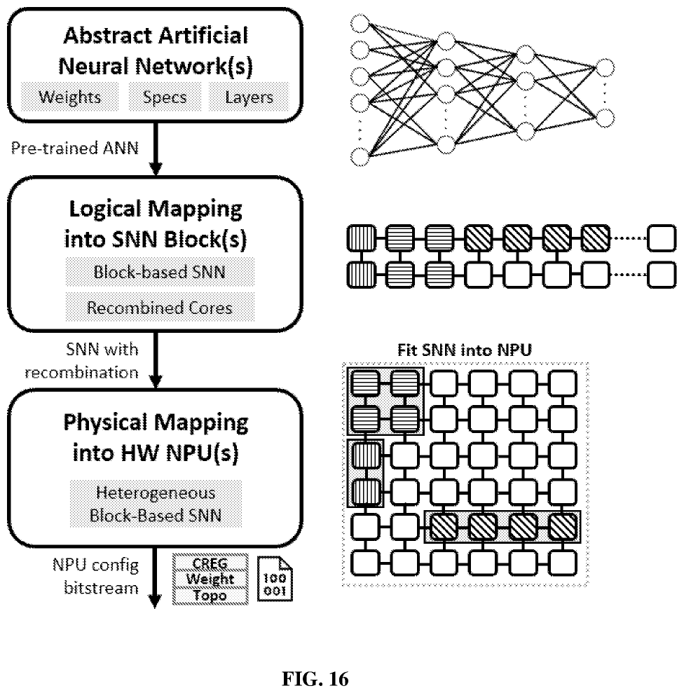

FIG. 16 shows an example SNN compiler flow that may be used to generate the configuration bitstream for the NPU 1010, according to various example embodiments of the present invention. In particular, FIG. 16 depicts a block-based SNN compiler that is optimizes the network by applying neurocore recombination. First, the system maps a pre-trained neural network into a block-based SNN, that is optimized to use neurocore recombination according to various example embodiments of the present invention whenever it is needed. The result is a logical SNN with recombined neurocores, that is then physically mapped onto the NPU hardware chip. This is then converted into a configuration bitstream comprising weights, CREG settings, and network topology data for all neurocores. The multicast, partial sum, and truncation CREG settings for the neurocores 714 may reflect the recombination sizes as determined by the compiler. For example, the compiler may determine the recombination levels of the neurocores using a higher level mapping algorithm, which may be automated using software.

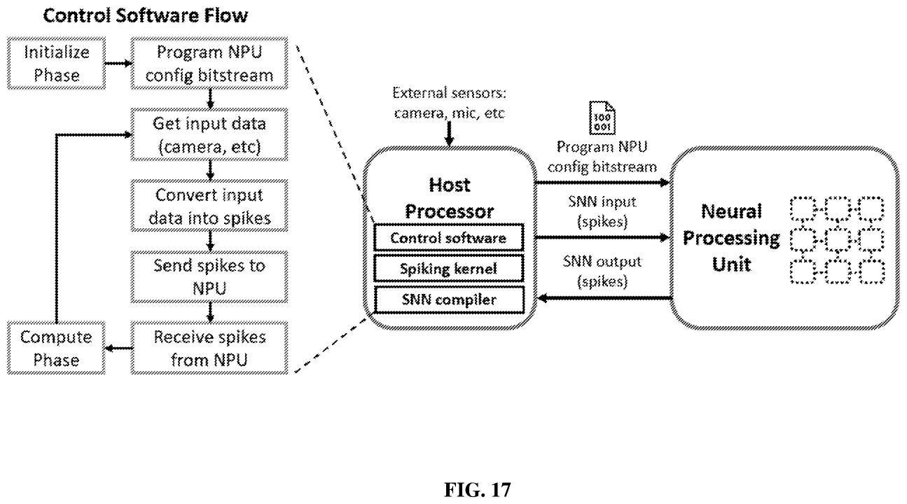

FIG. 17 shows an overview of an example host processor software control flow (e.g., corresponding to the host CPU 1020 as described hereinbefore), according to various example embodiments of the present invention. The initialization phase may include the compiler from FIG. 16, in addition to other related operating system or kernel initialization activities. After the initialization phase, the processor 1020 may program the configuration bitstream into the NPU 1010, which may be performed only once. After that the operational mode can begin, whereby the processor reads input data from the external sensors and converts these into a series of time-based neural packets. These packets may then be sent to the NPU 1010 for performing neural network computations, and after a brief period of time, a set of output neural packets including computation results in relation to the neural network computations may be received in return. These output neural packets (or lack thereof) may then be processed by the processor 1020 as desired or as appropriate to cater to the system level AI application.

### Performance and Evaluation

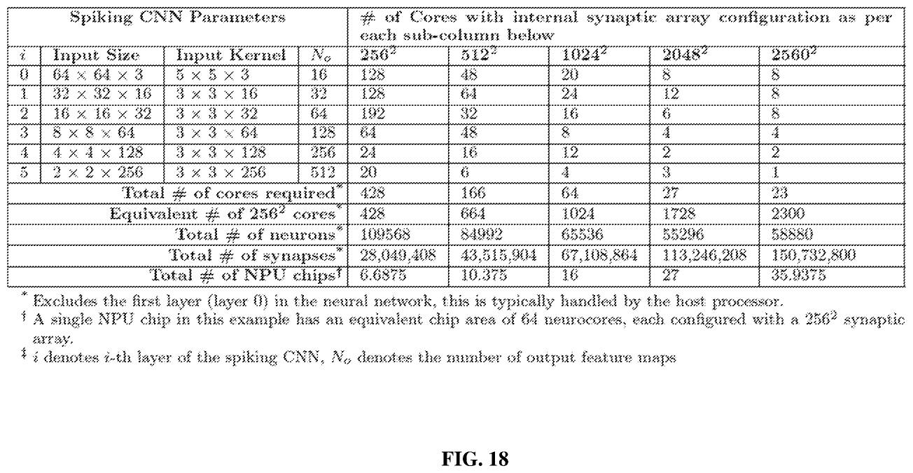

In addition to higher parallelism and flexibility in supporting neural networks with diverse fan-in/fan-out requirements, the benefits of partial summation and core recombination according to various example embodiments of the present invention can also be shown in terms of hardware resource usage efficiency. FIG. 18 shows the neurocore usage for a particular spiking CNN architecture under various core configurations. In particular, FIG. 18 shows the neurocore usage for mapping an example CNN onto the chip with respect to neurocore synaptic array configurations, whereby 2562 refers to a core with a 256×256 synaptic array, and so on.

In this example, the CNN architecture is used for image classification on 64×64×3 RGB input. The input kernels used are 5×5×3, 3×3×16, 3×3×32, 3×3×64, 3×3×128, 3×3×256 for layer 0 to 5, respectively. A stride of 2 with padding is used. When mapping CNN onto the neurosynaptic cores, the first layer (layer 0) is a transduction layer that converts RGB data (usually 8-bit per color) to neural packets. This function is usually run on a host processor (e.g., the host CPU 1020), whereby the last/output layer (not shown here) usually requires a normalized exponential function (e.g., softmax function), and each output pixel in an output feature map generally corresponds to a neuron.

For each core size configuration, FIG. 18 shows the number of cores needed to map a given layer (layer 0 to 5) as well as in total. As explained previously, the total number of cores only includes layer 1 to 5 because layer 0 is usually implemented on the host processor. Because different core sizes have different chip area footprint, for a fairer comparison, FIG. 18 also shows the equivalent number in 2562 cores and how many “standard” NPU chips would be needed, where it is assumed the chip area footprint is essentially determined by the number of synapses (and that the weight precision is the same for all synapses).

With these constraints, the remaining convolutional layers will require 428 cores with 256×256 synaptic array (denoted as 2562), or 166 cores of 5122 synaptic array, both assuming core recombination. Since 5122 cores are 4× as large as a 2562 core, 166 cores with 5122 synaptic arrays will occupy a chip area of roughly 4×166 (664) cores with 2562 synaptic array. This is approximately 1.55× (664÷428) the chip area of when using 2562 cores. This demonstrates the advantage of using smaller cores for CNN when mapping on neurocores with core recombination. The underlying reason is because of the Toeplitz mapping for the synaptic crossbar array within neurocores, whereby only the diagonal regions of the matrix can be utilized. The remainder of the matrix is essentially unused, leading to proportionally higher wastage on larger synaptic crossbar arrays.

In fact, the input kernel size for layer 5 in this example is 2304 (3×3×256), which is the minimum fan-in the neurocore needs (without core recombination) to support such a topology. If the neurocore size is fixed to 25602, it will require 23 cores, which is roughly 5.37× the core count of equivalent 2562 synaptic array configuration in terms of chip area (˜100×23=2300 cores). This is because of the extremely large overhead in earlier layers which did not require large cores. Hence, core usage can be significantly optimized by using smaller cores when implementing core recombination according to various example embodiments of the present invention.

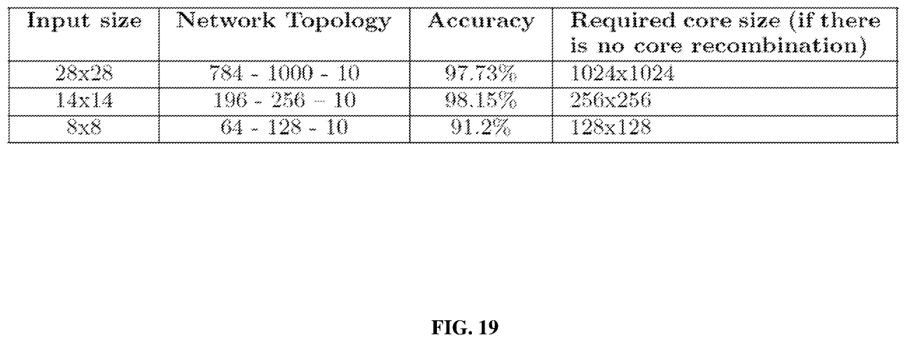

FIG. 19 shows the classification accuracy for artificial neural networks (ANNs) trained for MNIST. In particular, FIG. 19 shows how the accuracy will begin to drop significantly when the input size for an artificial neural network (ANN) trained for MNIST digits classification shrinks below a certain point (e.g. to meet core size constraints). As can be observed, the accuracy becomes very low, and this prompts typical hardware chips to implement cores with large sizes.

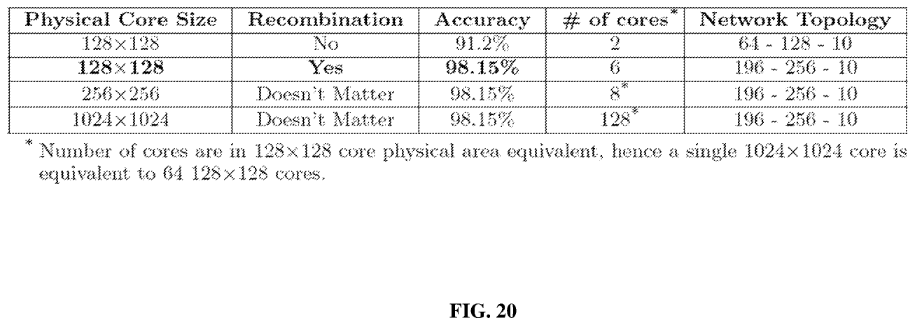

FIG. 20 shows the benefits of core recombination when applied for MNIST ANN. In particular, FIG. 20 shows the benefit of core recombination for MNIST ANN when using smaller neurocores. In this case, if 128×128 cores were used with core recombination, only 6 cores are required. But if 1024×1024 cores were used, the core size is so big that much of a core is unused, requiring a physical area of 128 cores (of 128×128 equivalent), irrespective of whether core recombination is supported (hence the note “Doesn't Matter”). Therefore, when using a smaller core size such as 128×128, the benefit of core recombination is most pronounced. Similar benefits can be observed when applying core recombination according to various example embodiments of the present invention to SNN implementations too.

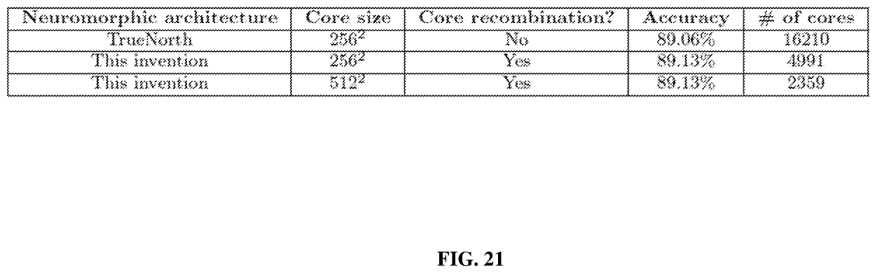

Finally, FIG. 21 shows the core utilization against prior art hardware that does not support core recombination. In particular, FIG. 21 shows the neurocore usage statistics for another example CNN-based image classification on an example dataset (not shown here) of 64×64×3 RGB input. The CNN layers were revised to “fit” onto such hardware for a given target application, in this case the IBM TrucNorth neuromorphic chip does not support core recombination, but its SDK allows CNN functionality with its own mapping and training algorithms. As can be seen, without core recombination, the number of required cores (in 2562 size) is more than triple at similar accuracy. Note that in FIG. 21, 5122 case, 2359 cores (of 5122) are required, which translates into roughly 2359×4=9436 cores (of 2562 equivalent). Therefore, when core recombination is supported, using a smaller physical core size usually results in more area-efficient mapping.

Accordingly, a methodology in which low power block-based neural processing units (NPUs) can internally scale and reconfigure itself to support different fan-in/fan-out requirements has been disclosed according to various example embodiments of the present invention. This is independent of the maximum fan-in/fan-out configuration of each of the NPU's internal hardware cores (which may be referred to as neural computing units, neural processing cores or simply as neurocores). These neurocores are responsible for implementing the individual layers of a neural network. This overcomes the fan-in/fan-out limitations of neural network layers implemented using these hardware-based neurocores with predetermined sizes. A scalable neural packet encoding format with parameterizable bitwidths for its fields is disclosed for inter-neurocore communications according to various example embodiments of the present invention, in order to support core recombination. According to various example embodiments, the scalable neural packet encoding format includes support for special packets, such as partial summation, multicasting, and debug packets. This allows for an optimal NPU hardware implementation in regards to power consumption, chip performance and area utilization.

For example, the neurocore recombination according to various example embodiments of the present invention may be applied to any systems or devices employing neural networks (e.g., artificial neural networks (ANNs) and spiking neural networks (SNNs)), such as edge devices with decision-making tasks. For example, the neurocore recombination may be implemented on FPGAs and CMOS-based processes. The neurocores 714 configured according to various example embodiments of the present invention has repeatable functionality and results. For example, a global clock signal and a reset signal to the components may be synchronized, and a global time step (T_{gync}) may be used to synchronize the neurocores 714 in the NPU(s) 1010.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A neural network processor system comprising:
a neural processing unit comprising a plurality of neural processing cores;
a router network comprising a plurality of routers communicatively coupled to the plurality of neural processing cores, respectively; and
a host processing unit communicatively coupled to the neural processing unit based on the router network and configured to coordinate the neural processing unit for performing neural network computations, wherein
each neural processing core of the plurality of neural processing cores comprises:
a control register block configured to receive and store partial sum configuration information from the host processing unit; and
a partial sum interface communicatively coupled to the control register block and configured to transmit a first partial sum neural packet generated by the neural processing core to a first another neural processing core of the plurality of neural processing cores and/or receive a second partial sum neural packet generated by a second another neural processing core of the plurality of neural processing cores, based on the partial sum configuration information stored in the neural processing core, and
a first set of neural processing cores of the plurality of neural processing cores are combinable based on the partial sum configuration information respectively stored therein to form a first neurosynaptic column chain.

2. The neural network processor system according to claim 1, wherein the partial sum configuration information respectively stored in the first set of neural processing cores are collectively configured to combine the first set of neural processing cores to form the first neurosynaptic column chain.

3. The neural network processor system according to claim 1, wherein for each neural processing core of the first neurosynaptic column chain except a last neural processing core thereof, the partial sum interface of the neural processing core is configured to transmit the first partial sum neural packet generated to the first another neural processing core of the first neurosynaptic column chain based on relative core addressing information included in the partial sum configuration information stored in the neural processing core.

4. The neural network processor system according to claim 3, wherein
the relative core addressing information of the partial sum configuration information comprises directional data indicating a direction relative to the neural processing core at which the first another neural processing core of the first neurosynaptic column chain is located, and
the first another neural processing core is immediately succeeding the neural processing core in the first neurosynaptic column chain.

5. The neural network processor system according to claim 4, wherein
the first partial sum neural packet generated by the neural processing core comprises an operation field comprising operation data indicating that the first partial sum neural packet is a partial sum neural packet, a payload field comprising partial sum data computed by the neural processing core and a destination field comprising destination data corresponding to the directional data stored in the neural processing core, and/or
the second partial sum neural packet generated by the second another neural processing core comprises an operation field comprising operation data indicating that the second partial sum neural packet is a partial sum neural packet, a payload field comprising partial sum data computed by the second another neural processing core and a destination field comprising destination data corresponding to the directional data stored in the second another neural processing core.

6. The neural network processor system according to claim 1, wherein the first set of neural processing cores is configured to perform partial summations in parallel.

7. The neural network processor system according to claim 1, wherein
for said each neural processing core of the plurality of neural processing cores,
the control register block of the neural processing core is further configured to receive and store axon input retransmission configuration information from the host processing unit; and
the neural processing core further comprises an axon input retransmission interface communicatively coupled to the control register block and configured to transmit a duplicate axon input neural packet generated by the neural processing core to another neural processing core of the plurality of neural processing cores, based on the axon input retransmission configuration information stored in the neural processing core, and
a second set of neural processing cores of the plurality of neural processing cores are combinable based on the axon input retransmission configuration information respectively stored therein to form a first neurosynaptic row chain.

8. The neural network processor system according to claim 7, wherein the axon input retransmission configuration information respectively stored in the second set of neural processing cores are collectively configured to combine the second set of neural processing cores to form the first neurosynaptic row chain.

9. The neural network processor system according to claim 7, wherein for each neural processing core of the first neurosynaptic row chain except a last neural processing core thereof, the axon input retransmission interface of the neural processing core is configured to transmit the duplicate axon input neural packet generated to said another neural processing core of the first neurosynaptic row chain based on relative core addressing information included in the axon input retransmission configuration information stored in the neural processing core.

10. The neural network processor system according to claim 9, wherein
the relative core addressing information of the axon input retransmission configuration information comprises directional data corresponding to a direction relative to the neural processing core at which said another neural processing core of the first neurosynaptic row chain is located, and
said another neural processing core is immediately succeeding the neural processing core in the first neurosynaptic row chain.

11. The neural network processor system according to claim 10, wherein the duplicate axon input neural packet comprises an operation field comprising operation data indicating that the duplicate axon input neural packet is an axon input neural packet, a payload field comprising duplicated axon input row data of an axon input neural packet received by the neural processing core and a destination field comprising destination data corresponding to the directional data stored in the neural processing core.

12. The neural network processor system according to claim 1, wherein
the neural processing unit further comprises a neural cache block,
the router network further comprises a router communicatively coupled to the neural cache block,
the host processing unit is further communicatively coupled to the neural cache block based on the router network,
the neural cache block comprises:
a control register block configured to receive and store axon input retransmission configuration information from the host processing unit; and
an axon input retransmission configuration interface configured to transmit a duplicate axon input neural packet generated by the neural cache block to another one or more neural processing cores of the plurality of neural processing cores based on the axon input retransmission configuration information stored in the neural cache block, and
a second set of neural processing cores of the plurality of neural processing cores are combinable based on the axon input retransmission configuration information stored in the neural cache block to form a first neurosynaptic row chain.

13. The neural network processor system according to claim 7, wherein
for said each neural processing core of the plurality of neural processing cores,
the control register block of the neural processing core is further configured to receive and store core truncation configuration information from the host processing unit; and
the neural processing core further comprises a core truncator communicatively coupled to the control register block and configured to modify a neurosynaptic row count and/or a neurosynaptic column count of the neural processing core based on the core truncation configuration information stored in the neural processing core.

14. The neural network processor system according to claim 7, wherein
the first neurosynaptic column chain is symmetrical or asymmetrical, and
the first neurosynaptic row chain is symmetrical or asymmetrical.

15. The neural network processor system according to claim 7, wherein a third set of neural processing cores of the plurality of neural processing cores are combinable based on the partial sum configuration information respectively stored in the first set of neural processing cores and the axon input retransmission configuration information respectively stored in the second set of neural processing cores to form a first combined neural processing core comprising the first set of neural processing cores forming the first neurosynaptic column chain and the second set of neural processing cores forming the first neurosynaptic row chain.

16. The neural network processor system according to claim 15, wherein the first combined neural processing core further comprises one or more first additional sets of neural processing cores forming one or more additional neurosynaptic column chains and one or more second additional sets of neural processing cores forming one or more additional neurosynaptic row chains.

17. A method of operating a neural network processor system,
the neural network processor system comprising:
a neural processing unit comprising a plurality of neural processing cores;
a router network comprising a plurality of routers communicatively coupled to the plurality of neural processing cores, respectively; and
a host processing unit communicatively coupled to the neural processing unit based on the router network and configured to coordinate the neural processing unit for performing neural network computations, wherein
each neural processing core of the plurality of neural processing cores comprises:
a control register block configured to receive and store partial sum configuration information from the host processing unit; and
a partial sum interface communicatively coupled to the control register block and configured to transmit a first partial sum neural packet generated by the neural processing core to a first another neural processing core of the plurality of neural processing cores and/or receive a second partial sum neural packet generated by a second another neural processing core of the plurality of neural processing cores, based on the partial sum configuration information stored in the neural processing core, and
a first set of neural processing cores of the plurality of neural processing cores are combinable based on the partial sum configuration information respectively stored therein to form a first neurosynaptic column chain, and
the method comprising:
executing, by the host processing unit, one or more neural network applications;
assigning, by the host processing unit, one or more neural network operations associated with the one or more neural network applications to the neural processing unit, comprising transmitting the respective partial sum configuration information to the control register block of each neural processing core of the first set of neural processing cores for combining the first set of neural processing cores to form the first neurosynaptic column chain; and
performing, by the neural processing unit, neural network computations to obtain computation results in relation to the one or more neural network operations.

18. The method according to claim 17, wherein
said assigning, by the host processing unit, the one or more neural network operations associated with the one or more neural network applications to the neural processing unit, further comprising transmitting axon input retransmission configuration information to the neural processing unit for combining a second set of neural processing cores to form a first neurosynaptic row chain.

19. A method of forming a neural network processor system, the method comprising:
providing a neural processing unit comprising a plurality of neural processing cores;
providing a router network comprising a plurality of routers communicatively coupled to the plurality of neural processing cores, respectively; and
providing a host processing unit communicatively coupled to the neural processing unit based on the router network and configured to coordinate the neural processing unit for performing neural network computations, wherein
each neural processing core of the plurality of neural processing cores comprises:
a control register block configured to receive and store partial sum configuration information from the host processing unit; and
a partial sum interface communicatively coupled to the control register block and configured to transmit a first partial sum neural packet generated by the neural processing core to a first another neural processing core of the plurality of neural processing cores and/or receive a second partial sum neural packet generated by a second another neural processing core of the plurality of neural processing cores, based on the partial sum configuration information stored in the neural processing core, and
a first set of neural processing cores of the plurality of neural processing cores are combinable based on the partial sum configuration information respectively stored therein to form a first neurosynaptic column chain.

20. The method of according to claim 19, wherein
for said each neural processing core of the plurality of neural processing cores,
the control register block of the neural processing core is further configured to receive and store axon input retransmission configuration information from the host processing unit; and
the neural processing core further comprises an axon input retransmission interface communicatively coupled to the control register block and configured to duplicate axon input row data of an axon input neural packet received by the neural processing core to generate a duplicate axon input neural packet and to transmit the duplicate axon input neural packet to another neural processing core of the plurality of neural processing cores, based on the axon input retransmission configuration information stored in the neural processing core, and
a second set of neural processing cores of the plurality of neural processing cores are combinable based on the axon input retransmission configuration information respectively stored therein to form a first neurosynaptic row chain.
